(19) United States
(12) Patent Application Publication
(10) Pub. No.: US 2024/0319625 A1
(43) Pub. Date: Sep. 26, 2024

(54) ELECTROSTATIC CHARGE IMAGE DEVELOPER, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Yosuke TSURUMI, Kanagawa (JP); Yasuo Kadokura, Kanagawa (JP); Moegi Iguchi, Kanagawa (JP)

(73) Assignee: FUJIFILM Business Innovation Corp., Tokyo (JP)

(21) Appl. No.: 18/456,107

(22) Filed: Aug. 25, 2023

(30) Foreign Application Priority Data
Mar. 20, 2023 (JP) 2023-043908

(51) Int. Cl. G03G 9/087

(52) U.S. Cl. CPC G03G 9/08797; G03G 9/08755; G03G 9/08795

(57) ABSTRACT

An electrostatic charge image developer contains a toner including toner particles that contain a binder resin, and an external additive, and a carrier having a true specific gravity of 3.0 g/cm³ or more and 4.0 g/cm³ or less, in which, in a dynamic viscoelasticity measurement of the toner, in a case where a loss tangent tan δ at a temperature of 90° C. and a strain of 1% is represented by D1 (90), a loss tangent tan δ at a temperature of 90° C. and a strain of 50% is represented by D50 (90), a loss tangent tan δ at a temperature of 150° C. and a strain of 1% is represented by D1 (150), and a loss tangent tan δ at a temperature of 150° C. and a strain of 50% is represented by D50 (150), each of D1 (90), D50 (90), D1 (150), and D50 (150) is 0.5 or more and 2.5 or less, a value of D50 (150)−D1 (150) is less than 1.5, and a value of D50 (90)−D1 (90) is less than 1.0.

### CROSS-REFERENCE TO RELATED APPLICATIONS

This application is based on and claims priority under 35 USC 119 from Japanese Patent Application No. 2023-043908 filed Mar. 20, 2023.

### BACKGROUND

### (i) Technical Field

The present invention relates to an electrostatic charge image developer, a process cartridge, an image forming apparatus, and an image forming method.

### (ii) Related Art

JP2020-042122A discloses a developer of an electrostatic latent image developing toner that contains toner particles containing a binder resin, in which the binder resin contains an amorphous resin and a crystalline resin, and in a case where strain dispersion of dynamic viscoelasticity is measured under the conditions of a temperature of 130° C., a frequency of 1 Hz, and a strain amplitude of 1.0% to 500%, and a stress integral value of a stress-strain curve at a strain amplitude of 100% is indicated as S130 and a slope of a major axis is indicated as θ130, the S130 is more than 0 Pa and 350,000 Pa or less, and the θ130 is more than 220 and less than 900.

JP2020-106685A discloses a developer of an electrostatic charge image developing toner that contains at least a binder resin and a release agent, in which the binder resin contains at least a crystalline resin, and a storage elastic modulus measured at a frequency of 1 Hz, 150° C., and a strain varied in a range of 0.01% to 1000% satisfies a specific relationship.

JP2020-042121A discloses a developer of an electrostatic latent image developing toner that contains toner particles containing a binder resin, in which the binder resin contains an amorphous vinyl resin and a crystalline resin, and in a case where strain dispersion of dynamic viscoelasticity is measured under the conditions of a temperature of 130° C., a frequency of 1 Hz, and a strain amplitude of 1.0% to 500%, and a stress integral value of a stress-strain curve at a strain amplitude of 100% is indicated as S130 and a slope of a major axis is indicated as θ130, the S130 is more than 0 Pa and 350,000 Pa or less, and the θ130 is 0° or more and less than 10°.

JP2019-144368A discloses a developer of an electrostatic charge image developing toner that contains toner base particles containing at least a binder resin and a release agent, and an external additive, in which the binder resin contains a crystalline resin, and a peak top value tan δ6° C./min of a loss tangent of the electrostatic charge image developing toner measured under the conditions of a frequency of 1 Hz and a temperature rising rate of 6° C./min at a temperature raised to 100° C. from 25° C. and a peak top value tan δ3° C./min of a loss tangent of the electrostatic charge image developing toner measured under the conditions of a frequency of 1 Hz and a temperature rising rate of 3° C./min at a temperature raised to 100° C. from 25° C. satisfy a specific relationship.

JP2013-160886A discloses a developer of an electrostatic charge image developing toner that contains a binder resin, a colorant, and a release agent, in which a rate γG′ of change in storage elastic modulus G′ is 50%<γG′<86%, a rate γG′ of change in loss elastic modulus G″ is more than 50%, a storage elastic modulus G′ in a range of 1% to 50% strain at a temperature of 150° C. is 5×10² to 3.5×10³ Pa·s, and the binder resin includes a non-crystalline resin and a crystalline resin.

JP2011-237793A and JP2011-237792A disclose a developer of an electrostatic charge image developing toner consisting of toner particles that contain a binder resin, in which the binder resin is found to have a domain matrix structure consisting of a high elasticity resin configuring a domain and a low elasticity resin configuring a matrix in an elasticity image showing a cross section of the toner particles captured with an atomic force microscope (AFM), an arithmetic average of a ratio of a major axis L of each domain to a minor axis W of each domain (L/W) is in a range of 1.5 to 5.0, a proportion of domains having the major axis L in a range of 60 to 500 nm is 80% by number or more, and a proportion of domains having the minor axis W in a range of 45 to 100 nm is 80% by number or more.

### SUMMARY

In image formation using an electrostatic charge image developer containing a toner, for example, a toner image transferred to a recording medium is fixed to the recording medium by heating and pressing. In a case where an electrostatic charge image developer containing a toner that is easily melted by heating is used to obtain excellent fixability, a difference between glossiness of a fixed image fixed under a high-temperature and high-pressure condition and glossiness of a fixed image fixed under a low-temperature and low-pressure condition may be large. In addition, in a case where an electrostatic charge image developer containing a toner that is easily melted by heating is used, fog may occur in the image.

Aspects of non-limiting embodiments of the present disclosure relate to an electrostatic charge image developer, a process cartridge, an image forming apparatus, and an image forming method that a difference in glossiness between a fixed image under a low-temperature and low-pressure condition and a fixed image under a high-temperature and high-pressure condition is smaller and fog of an image is further suppressed, as compared with a case where all of D1 (90), D50 (90), D1 (150), and D50 (150) are less than 0.5 or more than 2.5, a value of D50 (150)−D1 (150) is 1.5 or more, a value of D50 (90)−D1 (90) is 1.0 or more, a true specific gravity of a carrier is less than 3.0 g/cm³ or more than 4.0 g/cm³, or a content of a magnetic powder in the carrier is 80% by mass or less or 90% by mass or more.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

The above-described object is achieved by the following aspect.

According to an aspect of the present disclosure, there is provided an electrostatic charge image developer including:
a toner including toner particles that contain a binder resin, and an external additive; and
a carrier having a true specific gravity of 3.0 g/cm³ or more and 4.0 g/cm³ or less,
in which, in a dynamic viscoelasticity measurement of the toner, in a case where a loss tangent tan δ at a temperature of 90° C. and a strain of 1% is represented by D1 (90), a loss tangent tan δ at a temperature of 90° C. and a strain of 50% is represented by D50 (90), a loss tangent tan δ at a temperature of 150° C. and a strain of 1% is represented by D1 (150), and a loss tangent tan δ at a temperature of 150° C. and a strain of 50% is represented by D50 (150),
each of D1 (90), D50 (90), D1 (150), and D50 (150) is 0.5 or more and 2.5 or less,
a value of D50 (150)−D1 (150) is less than 1.5, and
a value of D50 (90)−D1 (90) is less than 1.0.

### BRIEF DESCRIPTION OF THE DRAWINGS

Exemplary embodiment(s) of the present invention will be described in detail based on the following figures, wherein:

FIG. 1 is a view schematically showing a configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

Hereinafter, exemplary embodiments of the present invention will be described in detail with reference to the accompanying drawings. The following descriptions and examples merely illustrate the exemplary embodiments, and do not limit the scope of the invention.

Regarding the numerical ranges described in stages in the present specification, the upper limit or lower limit of a numerical range may be replaced with the upper limit or lower limit of another numerical range described in stages. Furthermore, in the present specification, the upper limit or lower limit of a numerical range may be replaced with values described in examples.

In the present specification, (meth)acrylic means both acrylic and methacrylic.

In the present specification, the term “step” includes not only an independent step but a step that is not clearly distinguished from other steps as long as the intended purpose of the step is achieved.

Each component may include a plurality of corresponding substances.

In a case where the amount of each component in a composition is mentioned, and there are two or more kinds of substances corresponding to each component in the composition, unless otherwise specified, the amount of each component means the total amount of two or more kinds of the substances present in the composition.

### Electrostatic Charge Image Developer

### First Aspect

The electrostatic charge image developer (hereinafter, also referred to as “developer”) according to a first aspect contains a toner including toner particles that contain a binder resin, and a carrier having a true specific gravity of 3.0 g/cm³ or more and 4.0 g/cm³ or less, in which, in a dynamic viscoelasticity measurement of the toner, in a case where a loss tangent tan δ at a temperature of 90° C. and a strain of 1% is represented by D1 (90), a loss tangent tan δ at a temperature of 90° C. and a strain of 50% is represented by D50 (90), a loss tangent tan δ at a temperature of 150° C. and a strain of 1% is represented by D1 (150), and a loss tangent tan δ at a temperature of 150° C. and a strain of 50% is represented by D50 (150), each of D1 (90), D50 (90), D1 (150), and D50 (150) is 0.5 or more and 2.5 or less, a value of D50 (150)−D1 (150) is less than 1.5, and a value of D50 (90)−D1 (90) is less than 1.0.

Hereinafter, a toner in which each of D1 (90), D50 (90), D1 (150), and D50 (150) is 0.5 or more and 2.5 or less, a value of D50 (150)−D1 (150) is less than 1.5, and a value of D50 (90)−D1 (90) is less than 1.0 is referred to as “specific toner”; and a carrier having a true specific gravity of 3.0 g/cm³ or more and 4.0 g/cm³ or less is referred to as “first specific carrier”.

In the developer according to the first aspect, with the above-described configuration, a difference in glossiness between a fixed image under a low-temperature and low-pressure condition and a fixed image under a high-temperature and high-pressure condition is small, and fog of an image is suppressed. The reason is presumed as follows. Hereinafter, the difference in glossiness between a fixed image under a low-temperature and low-pressure condition and a fixed image under a high-temperature and high-pressure condition is also called “difference in glossiness conditions”.

As described above, in order to obtain good fixability, it is conceivable to use a developer containing a toner that is easily melted by heating. On the other hand, in a case where a developer containing the toner that is easily melted by heating is used for forming an image, the difference in glossiness conditions may be increased. It is presumed that such a difference may be made because the extent of deformation of the toner particles at a high temperature and a high strain is higher than the extent of deformation of toner particles at a low temperature and a low strain.

In addition, in the case where a developer containing the toner that is easily melted by heating is used for forming an image, fog may occur in the image. For example, in a case where a developer containing a toner and a carrier is stirred in a developing device, an external additive of the toner may be embedded in toner particles due to a mechanical load from the carrier. In the toner in which the external additive is embedded in the toner particles, since it is difficult for the external additive to retain electric charge, charging properties of the toner decreases, and a fluidity improving effect of the external additive cannot be obtained. In addition, as the fluidity of the toner decreases, chances of contact with the carrier decreases, so that it is more difficult for the toner to be charged, and the fog is more likely to occur. In addition, in a case where a carrier having a low true specific gravity is used in order to reduce the mechanical load from the carrier, friction is less likely to occur at the time of contact between the toner and the carrier, and charging due to the friction is less likely to occur, so that the fog may be more likely to occur.

On the other hand, in the first aspect, the specific toner, that is, the toner in which each of D1 (90), D50 (90), D1 (150), and D50 (150) is 0.5 or more and 2.5 or less, a value of D50 (150)−D1 (150) is less than 1.5, and a value of D50 (90)−D1 (90) is less than 1.0 is used.

Here, the strain of 1% in the dynamic viscoelasticity measurement means applying 1% of displacement with respect to a height (that is, a gap) of the sample. That is, the strain of 1% corresponds to the application of a displacement having a small magnitude, and corresponds to a case where a fixing pressure is low in the toner fixing step. On the other hand, the strain of 50% corresponds to a case where the fixing pressure is high in the toner fixing step. The temperature of 90° C. and strain of 1% correspond to a fixing condition at a low temperature and a low pressure, the temperature of 150° C. and strain of 50% correspond to a fixing condition at a high temperature and a high pressure, and each loss tangent tan δ corresponds to the extent of deformation of the toner under each fixing condition.

In the specific toner, the change in loss tangent relative to the change in strain is small at both of 90° C. and 150° C. Therefore, it is presumed that, because the viscoelasticity of the toner at a high temperature and a high strain is similar to the viscoelasticity of the toner at a low temperature and a low strain, even though an image is fixed under a high-temperature and high-pressure condition, the difference in glossiness between the obtained fixed image and a fixed image fixed under a low-temperature and low-pressure condition is small.

In the first aspect, the specific toner in which each of D1 (90), D50 (90), D1 (150), and D50 (150) is 0.5 or more and 2.5 or less is used in combination with the first specific carrier having a true specific gravity of 3.0 g/cm³ or more and 4.0 g/cm³ or less. By the combination of the toner having the appropriate viscoelasticity and the carrier having the appropriately small specific gravity, it is presumed that the embedding of the external additive in the toner particles is suppressed, and triboelectrification is likely to occur in a case where the toner and the carrier are in contact with each other, so that the fog of the image is less likely to occur.

For the above reasons, in the first aspect, it is presumed that the difference in glossiness conditions is small and the fog of the image is suppressed.

The loss tangent of the above-described toner is determined as follows.

Specifically, by a press molding machine, a toner as a measurement target is molded into tablets at room temperature (25° C.), thereby producing a measurement sample. Using a rheometer, dynamic viscoelasticity of the measurement sample is measured under the following conditions. From each of the obtained storage elastic modulus curve and the loss elastic modulus curve, the loss tangent tan δ at a temperature of 90° C. or 150° C. and a strain of 1% or 50% is determined, thereby obtaining D1 (90), D50 (90), D1 (150), and D50 (150).
Measurement Conditions
Measurement device: rheometer ARES-G2 (manufactured by TA Instruments)
Fixture: 8 mm parallel plates
Gap: adjusted to 3 mm
Frequency: 1 Hz

The method for obtaining the specific toner is not particularly limited.

Examples of the method for obtaining the specific toner include a method of evenly incorporating resin particles into both the region close to the surface of toner particles and the region close to the center of the toner particles, the resin particles having the storage elastic modulus G′ of 1×10⁴ Pa or more and 1×10⁶ Pa or less in a range of 90° C. or higher and 150° C. or lower in the dynamic viscoelasticity measurement at a temperature rising rate of 2° C./min.

Hereinafter, the resin particles having the storage elastic modulus G′ of 1×10⁴ Pa or more and 1×10⁶ Pa or less in a range of 90° C. or higher and 150° C. or lower are also called “specific resin particles”.

It is not clear why the specific toner can be easily obtained by the method of evenly dispersing the specific resin particles in both the region close to the surface of the toner particles and the region close to the center of the toner particles, but is presumed to be as follows.

As described above, the specific resin particles are particles that have the storage elastic modulus G′ of 1×10⁴ Pa or more even though the temperature is raised to 150° C. That is, the specific resin particles are particles having a high elastic modulus at a high temperature. Therefore, it is presumed that, in a case where the toner particles contain the specific resin particles, the overall loss tangent of the toner at a high temperature and a high strain is unlikely to increase, and the difference between the overall loss tangent of the toner at a high temperature and a high strain and the overall loss tangent of the toner at a low temperature and a low strain is reduced.

In particular, it is presumed that, in a case where the specific resin particles are evenly dispersed in both the region close to the surface of the toner particles and the region close to the center of the toner particles, both the loss tangent of the toner at a low temperature and a low strain and the loss tangent of the toner at a high temperature and a high strain are reduced, and the difference between these loss tangents is also reduced, and as a result, the specific toner is easily obtained.

The storage elastic modulus G′ of the resin particles, and a loss tangent tan δ and a glass transition temperature Tg of the resin particles, that will be described later, are determined as follows.

Specifically, by applying pressure to the resin particles as a measurement target, a disk-shaped sample having a thickness of 2 mm and a diameter of 8 mm is produced and used as a measurement sample. In a case of measuring the resin particles contained in the toner particles, the resin particles are isolated from the toner particles, and then used for producing the measurement sample. Examples of the method for isolating the resin particles from the toner particles include a method of immersing the toner particles in a solvent that dissolves the binder resin and does not dissolve the resin particles, and dissolving the binder resin in the solvent so as to isolate the resin particles.

The obtained disk-shaped sample as a measurement sample is interposed between parallel plates having a diameter of 8 mm, and dynamic viscoelasticity is measured under the following conditions by raising the measurement temperature from 10° C. to 150° C. at 2° C./min at a strain of 0.1% to 100%. From each of the storage elastic modulus curve and the loss elastic modulus curve obtained by the measurement, the storage elastic modulus G′ and the loss tangent tan δ are determined. In addition, the peak temperature of the loss tangent tan δ is determined as the glass transition temperature Tg.
Measurement Conditions
Measurement device: rheometer ARES-G2 (manufactured by TA Instruments)
Gap: adjusted to 3 mm
Frequency: 1 Hz

The above-described true specific gravity of the carrier is measured by a pycnometer method specified in JIS K0061: 2001 “Test methods for density and relative density of chemical products”.

A method of controlling the true specific gravity of the carrier is not particularly limited. The true specific gravity of the carrier is controlled by, for example, increasing or decreasing the amount of the resin contained in the magnetic particles while containing the resin; and increasing or decreasing a coverage of a resin layer.

### Second Aspect

The developer according to the second aspect contains the above-described specific toner, and a carrier containing core particles in which a magnetic powder is dispersed in a resin, in which a content of the magnetic powder with respect to a total amount of the carrier is more than 80% by mass and less than 90% by mass.

Hereinafter, a carrier containing core particles in which a magnetic powder is dispersed in a resin, in which a content of the magnetic powder with respect to a total amount of the carrier is more than 80% by mass and less than 90% by mass, is also referred to as “second specific carrier”.

With the above-described configuration, the developer according to the second aspect has a small difference in glossiness conditions and suppresses fog of an image. The reason is presumed as follows.

As described above, in order to obtain good fixability, in a case where a developer containing the toner that is easily melted by heating is used for forming an image, the difference in glossiness conditions may be increased, and the fog of the image may occur.

On the other hand, in the second aspect, by using the specific toner, a fixed image having a small difference in glossiness conditions is obtained. In addition, in the second aspect, the specific toner in which each of D1 (90), D50 (90), D1 (150), and D50 (150) is 0.5 or more and 2.5 or less is used in combination with the second specific carrier in which the content of the magnetic powder is more than 80% by mass and less than 90% by mass. The specific gravity of the second specific carrier is smaller than a specific gravity of a carrier in which the content of the magnetic powder is 90% by mass or more. Therefore, in addition to the suppressing of the embedding of the external additive in the toner particles, by the combination of the carrier having the appropriately small specific gravity and the toner having the appropriate viscoelasticity, it is presumed that the embedding of the external additive in the toner particles is suppressed, and triboelectrification is likely to occur in a case where the toner and the carrier are in contact with each other, so that the fog of the image is less likely to occur.

For the above reasons, in the second aspect, it is presumed that the difference in glossiness conditions is small and the fog of the image is suppressed.

Hereinafter, a developer corresponding to both of the developer according to the first aspect and the developer according to the second aspect will be referred as “developer according to the present exemplary embodiment”. An example of the developer according to the embodiment of the present invention may be a developer corresponding to at least one of the developer according to the first aspect or the developer according to the second aspect.

Hereinafter, details of the toner and the carrier contained in the developer according to the present exemplary embodiment will be described.

### Toner

The toner according to the present exemplary embodiment includes toner particles and an external additive.

### Toner Particles

The toner particles contain at least a binder resin, and may contain other components as necessary.

For example, the toner particles preferably contain resin particles in addition to the binder resin.

By further containing the resin particles in the toner particles, it is presumed that the extent of deformation of the toner-fixed image with respect to the fixing pressure is suppressed, and a fixed image with a small difference in glossiness is obtained.

The above-described resin particles are, for example, preferably crosslinked resin particles.

The “crosslinked resin particles” herein refer to resin particles having a crosslinked structure between specific atoms in the polymer structure contained in the resin particles.

In a case where crosslinked resin particles are used as the resin particles, the storage elastic modulus G′ of the specific resin particles is likely to fall into the above range in a range of 90° C. or higher and 150° C. or lower, and the specific toner is easily obtained.

As the above-described crosslinked resin particles, for example, styrene (meth)acrylic resin particles are preferable.

In a case where the crosslinked resin particles are the styrene (meth)acrylic resin particles, the storage elastic modulus G′ of the specific resin particles is likely to fall into the above range in a range of 90° C. or higher and 150° C. or lower, and the specific toner is easily obtained.

As described above, from the viewpoint of obtaining the specific toner, for example, it is preferable that the toner particles contain the specific resin particles as the above-described resin particles.

Hereinafter, as an example of the toner particles contained in the specific toner, toner particles containing a binder resin and the specific resin particles will be described.

The toner particles include, for example, the binder resin, the specific resin particles, and as necessary, a colorant, a release agent, and other additives.

### Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

For example, the binder resin preferably contains a polyester resin.

In a case where the binder resin contains a polyester resin, in a case of using the styrene (meth)acrylic resin particles as the specific resin particles, a difference between an SP value (S) as a solubility parameter of the specific resin particles and an SP value (R) as a solubility parameter of the binder resin (SP value (S)−SP value (R)), which will be described later, is likely to fall into, for example, a preferred numerical range. Therefore, the specific resin particles are likely to be dispersed in the toner particles, and as a result, the difference in glossiness conditions is reduced.

In a case where the difference (SP value (S)−SP value (R)) is within the above-described range, compared to a case where the difference is too small, since affinity between the binder resin and the specific resin particles is high, it is possible to suppress a decrease in dispersibility due to partial compatibility. In addition, in a case where the difference (SP value (S)−SP value (R)) is within the above-described range, compared to a case where the difference is too large, since the affinity between the binder resin and the specific resin particles is low, the specific resin particles are prevented from being included in the toner particles and discharged to the surface of the toner particles or to the outside of the toner particles.

For example, it is preferable that the binder resin contains a crystalline resin and an amorphous resin.

The crystalline resin means a resin having a clear endothermic peak instead of showing a stepwise change in endothermic amount, in differential scanning calorimetry (DSC).

On the other hand, the amorphous resin means a resin that shows only a stepwise change in amount of heat absorbed instead of having a clear endothermic peak in a case where the resin is measured by a thermoanalytical method using differential scanning calorimetry (DSC), and stays as a solid at room temperature but turns thermoplastic at a temperature equal to or higher than a glass transition temperature.

Specifically, for example, the crystalline resin refers to a resin that has a half-width of an endothermic peak of 10° C. or less in a case where the resin is measured at a temperature rising rate of 10° C./min, and the amorphous resin refers to a resin that has a half-width of more than 10° C. or a resin for which a clear endothermic peak is not observed.

The crystalline resin will be described.

Examples of the crystalline resin include known crystalline resins such as a crystalline polyester resin, and a crystalline vinyl resin (such as a polyalkylene resin and a long-chain alkyl (meth)acrylate resin). Among the crystalline resins, in view of mechanical strength and low-temperature fixability of the toner, for example, a crystalline polyester resin is preferable.

### Crystalline Polyester Resin

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and even more preferably 60° C. or higher and 85° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The weight-average molecular weight (Mw) of the crystalline polyester resin is, for example, preferably 6,000 or more and 35,000 or less.

The crystalline polyester resin can be obtained by a well-known manufacturing method, for example, same as the amorphous polyester resin.

In a case where the toner particles contain the crystalline resin, a content of the crystalline resin with respect to the total mass of the binder resin is, for example, preferably 4% by mass or more and 50% by mass or less, more preferably 6% by mass or more and 30% by mass or less, and even more preferably 8% by mass or more and 20% by mass or less.

In a case where the content of the crystalline resin is within the above-described range, better fixability is obtained as compared with a case where the ratio of the crystalline resin contained in the toner particles is lower than the above-described range. In addition, in a case where the content of the crystalline resin is within the above-described range, compared to a case where the content of the crystalline resin is higher than the above-described range, an excessive increase in glossiness of the fixed image fixed under a high-temperature and high-pressure condition due to too much crystalline resin having relatively low elasticity is further suppressed. As a result, the difference in glossiness conditions is reduced.

The amorphous resin will be described.

Examples of the amorphous resin include known amorphous resins such as an amorphous polyester resin, an amorphous vinyl resin (such as a styrene acrylic resin), an epoxy resin, a polycarbonate resin, and a polyurethane resin. Among the amorphous resins, for example, an amorphous polyester resin or an amorphous vinyl resin (particularly, a styrene acrylic resin) is preferable, and an amorphous polyester resin is more preferable.

### Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC HLC-8120GPC manufactured by Tosoh Corporation as a measurement device, TSKgel Super HM-M (15 cm) manufactured by Tosoh Corporation as a column, and THE as a solvent. The weight-average molecular weight and the number-average molecular weight are calculated using a molecular weight calibration curve plotted using a monodisperse polystyrene standard sample from the measurement results.

The amorphous polyester resin is obtained by a well-known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the main component.

The binder resin preferably contains, for example, a polyester resin having an aliphatic dicarboxylic acid unit (that is a structural unit derived from an aliphatic dicarboxylic acid). In a case where the polyester resin as the binder resin has an aliphatic dicarboxylic acid unit, compared to a case where the polyester resin has only an aromatic dicarboxylic acid unit, since flexibility of the binder resin increases, it is possible to disperse the specific resin particles in a more uniform state, and it is possible to further reduce the range of change in loss tangent tan δ.

In addition, the binder resin preferably contains, for example, an amorphous polyester resin having an aliphatic dicarboxylic acid unit and a crystalline polyester resin having an aliphatic dicarboxylic acid unit. In a case where the binder resin includes an amorphous polyester resin and a crystalline polyester resin, since both resins have an aliphatic dicarboxylic acid unit, the specific resin particles can be dispersed more uniformly.

As the aliphatic dicarboxylic acid, for example, a saturated aliphatic dicarboxylic acid represented by General Formula “HOOC—(CH₂)ₙ—COOH” can be preferably used. n in the general formula is, for example, preferably 4 to 20, and more preferably 4 to 12.

The content of the binder resin with respect to the total amount of the toner particles is, for example, preferably 40% by mass or more and 95% by mass or less, more preferably 50% by mass or more and 90% by mass or less, and even more preferably 60% by mass or more and 85% by mass or less.

In a case where the content of the specific resin particles is set as 1, a ratio of the content of the crystalline resin to the content of the specific resin particles is, for example, preferably 0.2 or more and 10 or less, and more preferably 1 or more and 5 or less.

In a case where the ratio of the content of the crystalline resin to the content of the specific resin particles is within the above-described range, compared to a case of being less than 0.2, a decrease in meltability of the toner due to an excessively small amount of the low-viscosity component at 90° C. or higher and 150° C. or lower in the toner and an increase in the contribution of the specific resin particles, that are highly elastic components, is suppressed, and the fixability is improved.

In addition, in a case where the ratio of the content of the crystalline resin to the content of the specific resin particles is within the above-described range, compared to a case of being more than 10, it is possible to suppress the extent of deformation of the toner due to heat and pressure from the fixing device due to excessive reduction components, and to reduce the difference in glossiness due to fixing conditions.

In a case where the content of the specific resin particles is set as 1, a ratio of the content of the amorphous resin to the content of the specific resin particles is, for example, preferably 1.3 or more and 45 or less, and more preferably 3 or more and 15 or less.

### Specific Resin Particles

The specific resin particles are not particularly limited as long as the specific resin particles are resin particles having the storage elastic modulus G′ of 1×10⁴ Pa or more and 1×10⁶ Pa or less in a range of 90° C. or higher and 150° C. or lower in dynamic viscoelasticity measurement at a temperature rising rate of 2° C./min.

The storage elastic modulus G′ of the specific resin particles in the range of 90° C. or higher and 150° C. or lower is, for example, preferably 1×10⁵ Pa or more and 8×10⁵ Pa or less, and more preferably 1×10⁵ Pa or more and 6×10⁵ Pa or less.

In a case where the resin particles having the storage elastic modulus G′ within the above-described range in the range of 90° C. or higher and 150° C. or lower are used, an excessive increase of glossiness of a fixed image fixed under a high-temperature and high-pressure condition is further suppressed as compared with a case where resin particles having the storage elastic modulus G′ lower than the above-described range is used. As a result, the difference in glossiness conditions is reduced. In addition, in a case where the resin particles having the storage elastic modulus G′ within the above-described range in the range of 90° C. or higher and 150° C. or lower are used, deterioration of fixability resulting from excessively high elasticity of toner particles is further suppressed, and better fixability is likely to obtained as compared with a case where resin particles having the storage elastic modulus G′ lower than the above-described range are used.

In the dynamic viscoelasticity measurement at a temperature rising rate of 2° C./min, a loss tangent tan δ of the specific resin particles in a range of 30° C. or higher and 150° C. or lower is, for example, preferably 0.01 or more and 2.5 or less. In particular, in a range of 65° C. or higher and 150° C. or lower, the loss tangent tan δ of the specific resin particles is, for example, more preferably 0.01 or more and 1.0 or less, and even more preferably 0.01 or more and 0.5 or less.

In a case where the loss tangent tan δ of the specific resin particles within the above-described range in the range of 30° C. or higher and 150° C. or lower, the toner particles are more likely to be deformed during fixing, and better fixability is likely to be obtained as compared with a case where the loss tangent tan δ of the specific resin particles is lower than the above-described range. In addition, in a case where the loss tangent tan δ of the specific resin particles in a range of 65° C. or higher and 150° C. or lower, that is the temperature at which the toner particles are more likely to be deformed, is within the above-described range, an excessive increase of glossiness of a fixed image fixed under a high-temperature and high-pressure condition is further suppressed as compared with a case where the loss tangent tan δ of the specific resin particles is higher than the above-described range. As a result, the difference in glossiness conditions is reduced.

### Crosslinked Resin Particles

The specific resin particles are, for example, preferably crosslinked resin particles.

Here, in order to encapsulate the specific resin particles in the toner particles, for example, it is preferable that the specific resin particles have a high affinity with the binder resin. Examples of a method for increasing the above-described affinity include a method of controlling the SP value and a method of using a surfactant as a dispersant for the specific resin particles. However, in a case where specific resin particles having a high affinity with the binder resin are used, since the specific resin particles are composed of an organic polymer unlike inorganic fillers, carbon black, metal particles, and the like, the specific resin particles tend to be compatible with the binder resin, and the dispersibility may be lowered.

On the other hand, in a case where specific resin particles having a low affinity with the binder resin are used, the specific resin particles are difficult to be encapsulated in the toner particles, and may be discharged to the surface of the toner particles or the outside of the toner particles.

By using the specific resin particles having an intermediate affinity with the binder resin, that is between the specific resin particles having a high affinity and the specific resin particles having a low affinity, it is possible to encapsulate the specific resin particles in the toner particles to some extent. However, regardless of toner manufacturing method such as an emulsification aggregation method and a kneading and pulverizing method, in a case where the specific resin particles come into contact with each other, the specific resin particles have a high affinity because the specific resin particles are the same type of material, and in some cases, the specific resin particles are unevenly distributed while maintaining the contact state, and it is difficult to evenly dispose the specific resin particles in the toner particles. It is considered that one of the reasons why the specific resin particles maintain the state of being in contact with each other is that polymer chains of polymer components constituting the specific resin particles are entangled at the time of contact.

Therefore, by using the crosslinked resin particles as the specific resin particles, it is possible to suppress the entanglement of the polymer chains, to prevent the polymer chains from being in the state of being in contact with each other, and to disperse the specific resin particles evenly in the toner particles.

Examples of the crosslinked resin particles include crosslinked resin particles crosslinked by an ionic bond (ionically crosslinked resin particles), and crosslinked resin particles crosslinked by a covalent bond (covalently crosslinked resin particles). Among these crosslinked resin particles, for example, crosslinked resin particles crosslinked by a covalent bond are preferable.

Examples of the type of the resin used for the crosslinked resin particles include a polyolefin-based resin (such as polyethylene and polypropylene), a styrene-based resin (such as polystyrene and α-polymethylstyrene), a (meth)acrylic resin (such as polymethyl methacrylate and polyacrylonitrile), an epoxy resin, a polyurethane resin, a polyurea resin, a polyamide resin, a polycarbonate resin, a polyether resin, a polyester resin, and copolymer resins of these compounds. As necessary, each of these resins may be used alone, or two or more of these resins may be used in combination.

Among the above-described resins, as the resin used for the crosslinked resin particles, for example, a styrene (meth)acrylic resin that is a copolymer resin of a styrene-based resin and a (meth)acrylic resin is preferable.

That is, as the crosslinked resin particles, for example, styrene (meth)acrylic resin particles are preferable.

Examples of the styrene-(meth)acrylic resin include a resin obtained by polymerizing the following styrene-based monomer and (meth)acrylic acid-based monomer by radical polymerization.

Examples of the styrene-based monomer include styrene, α-methylstyrene, vinylnaphthalene; alkyl-substituted styrene with an alkyl chain, such as 2-methylstyrene, 3-methylstyrene, 4-methylstyrene, 2-ethylstyrene, 3-ethylstyrene, and 4-ethylstyrene; halogen-substituted styrene such as 2-chlorostyrene, 3-chlorostyrene, and 4-chlorostyrene; and fluorine-substituted styrene such as 4-fluorostyrene and 2,5-difluorostyrene. Among the styrene-based monomers, for example, styrene or α-methylstyrene is preferable.

Examples of the (meth)acrylic acid-based monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylonitrile, and (meth)acrylamide. Among these, for example, n-butyl (meth)acrylate or 2-carboxyethyl (meth)acrylate is preferable.

In the crosslinked resin particles, examples of a crosslinking agent for crosslinking the resin include aromatic polyvinyl compounds such as divinylbenzene and divinylnaphthalene; polyvinyl esters of aromatic polyvalent carboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridine dicarboxylate; vinyl esters of unsaturated heterocyclic compound carboxylic acid, such as vinyl pyromutate, vinyl furan carboxylate, vinyl pyrrole-2-carboxylate, and vinyl thiophene carboxylate; (meth)acrylic acid esters of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched substituted polyhydric alcohols, such as neopentylglycol dimethacrylate and 2-hydroxy,1,3-diacryloxypropane; and polyvinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetone dicarboxylate, divinyl glutarate, 3,3′-divinylthiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. One kind of crosslinking agent may be used alone, or two or more kinds of crosslinking agents may be used in combination.

Among these crosslinking agents, for example, it is preferable to use a bifunctional alkyl acrylate having an alkylene chain having 6 or more carbon atoms as the crosslinking agent for crosslinking the resin. That is, for example, the crosslinked resin particles preferably have a bifunctional alkyl acrylate as a constitutional unit, and the number of carbon atoms in the alkylene chain of the bifunctional alkyl acrylate is 6 or more.

By using crosslinked resin particles having the bifunctional alkyl acrylate as a constitutional unit, in which the number of carbon atoms in the alkylene chain is 6 or more, it is easier to obtain the specific toner. For the specific toner, it is necessary to suppress the extent of deformation of the toner particles within a certain range even under high-pressure fixing conditions in order to suppress the difference in glossiness. In a case where a difference in elasticity between the specific resin particles as the crosslinked resin particles and the binder resin is too large, it may be difficult to obtain the effect of suppressing the change in loss tangent tan δ by the specific resin particles. Therefore, for example, it is preferable to control crosslinkability such that the elasticity of the specific resin particles is not too high. In a case where a crosslinking density of the specific resin particles is high (that is, a distance between crosslinking points is short), elasticity is too high, but in a case where a bifunctional acrylate having a long alkylene chain is used as the crosslinking agent, the crosslinking density is low (that is, the distance between crosslinking points is long), and it is possible to prevent the elasticity of the specific resin particles from being too high. As a result, the difference in glossiness can be further suppressed.

From the viewpoint of adjusting the crosslinking density to an appropriate range, the number of carbon atoms in the alkylene chain of the bifunctional alkyl acrylate is, for example, preferably 6 or more, more preferably 6 or more and 12 or less, and even more preferably 8 or more and 12 or less. More specific examples of the bifunctional alkyl acrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate, and among these, for example, 1,10-decanediol diacrylate or 1,10-decanediol dimethacrylate is preferable.

In a case where the specific resin particles are a polymer of a composition for forming specific resin particles containing a styrene-based monomer, a (meth)acrylic acid-based monomer, and a crosslinking agent, the amount of the crosslinking agent contained in the composition may be adjusted so that the viscoelasticity of the specific resin particles is controlled. For example, by increasing the amount of the crosslinking agent contained in the composition, it is easy to obtain resin particles having a high storage elastic modulus G′. The content of the crosslinking agent in the composition for forming the specific resin particles with respect to, for example, the total of 100 parts by mass of the styrene-based monomer, the meth)acrylic acid-based monomer, and the crosslinking agent is preferably 0.3 parts by mass or more and 5.0 parts by mass or less, more preferably 0.5 parts by mass or more and 2.5 parts by mass or less, and even more preferably 1.0 parts by mass or more and 2.0 parts by mass or less.

The glass transition temperature Tg of the specific resin particles obtained from the dynamic viscoelasticity measurement is, for example, preferably 10° C. or higher and 45° C. or lower. In a case where the glass transition temperature Tg of the specific resin particles is 10° C. or higher and 45° C. or lower, a toner in which the difference in glossiness between the fixed image in low-temperature and low-pressure conditions and the fixed image in high-temperature and high-pressure conditions is further reduced while obtaining the good fixability of the toner is obtained.

Further, the glass transition temperature Tg of the specific resin particles is, for example, more preferably 15° C. or higher and 40° C. or lower, and even more preferably 20° C. or higher and 35° C. or lower.

In a case where the glass transition temperature Tg of the specific resin particles is within the above-described range, compared to a case where Tg is too low, since a difference in Tg with the binder resin is large, uneven distribution of the resin particles in the toner particles is suppressed, the dispersion state of the specific resin particles that is nearly uniform is easily maintained, the effect of suppressing deformation against pressure during fixing is easily obtained, and the difference in glossiness is reduced. In addition, in a case where the glass transition temperature Tg of the specific resin particles is within the above-described range, compared to a case where Tg is too high, deterioration of the low-temperature fixability due to deterioration of meltability of the binder resin is suppressed.

A number-average particle size of the specific resin particles is, for example, preferably 60 nm or more and 300 nm or less, more preferably 100 nm or more and 200 nm or less, and even more preferably 130 nm or more and 170 nm or less.

In a case where the number-average particle size of the specific resin particles is within the above-described range, compared to a case of being lower than the above-described range, deterioration of fixability resulting from the fact that the toner particles are easily affected by high elasticity of the specific resin particles is suppressed, and better fixability is obtained. In addition, in a case where the number-average particle size of the specific resin particles is within the above-described range, compared to a case of being higher than the above-described range, since the specific resin particles are likely to disperse in a nearly uniform state in the toner particles, the toner tends to have similar viscoelasticity at a high temperature and a high strain and at a low temperature and a low strain. As a result, the difference in glossiness conditions is reduced.

The number-average particle size of the specific resin particles is a value measured using a transmission electron microscope (TEM).

As the transmission electron microscope, for example, JEM-1010 manufactured by JEOL Ltd. DATUM Solution Business Operations can be used.

Hereinafter, a method of measuring the number-average particle size of the specific resin particles will be specifically described.

The toner particles are cut in a thickness of approximately 0.3 μm with a microtome. A cross section of the toner particles is imaged at 4,500× magnification by using the transmission electron microscope, equivalent circle diameters of 1,000 resin particles dispersed in the toner particles are calculated based on the cross-sectional areas of the particles, and an arithmetic average thereof is calculated and adopted as the number-average particle size.

In addition, the number-average particle size of the specific resin particles may be a value measured by a laser diffraction type particle size distribution analyzer (for example, LA-700 manufactured by HORIBA, Ltd.) for the specific resin particle dispersion.

For example, it is preferable that the specific resin particles are evenly contained in both a region close to the surface of the toner particles (hereinafter, also referred to as “surface region”) and a region close to the center of the toner particles (hereinafter, also referred to as “central region”). In a case where the specific resin particles are contained in both the surface region and the central region, the difference in glossiness conditions is further reduced as compared with a case where the specific resin particles are contained in only one of the surface region or the central region.

For example, in a case where the specific resin particles are contained only in the surface region, it is considered that the toner particles may be deformed a little at a low-temperature and low-pressure condition by being affected by the viscoelasticity in the surface region but may be deformed much at a high-temperature and high-pressure condition due to the influence of the viscoelasticity of the central region. Therefore, the difference in glossiness conditions may be increased. In addition, in a case where the specific resin particles are contained only in the central region, the toner particles are deformed a little under a low-temperature and low-pressure condition and make the specific resin particles poorly dispersed (unevenly distributed) in a fixed image, but deformed much under a high-temperature and high-pressure condition and are likely to make the specific resin particles excellently dispersed (practically evenly dispersed) in a fixed image. In a case where the specific resin particles are poorly dispersed in the fixed image, the portion where the specific resin particles exist forms a projection that is not easily deformed, and the portion where the specific resin particles do not exist forms a depression that is easily deformed, which leads to reduction of glossiness. In a case where the specific resin particles are excellently dispersed, the above-described state is suppressed, and the glossiness is improved. Therefore, the difference in glossiness conditions may be increased.

On the other hand, in a case where the specific resin particles are contained in both the surface region and the central region, unlike the case where the specific resin particles are contained only in the surface region or the case where the specific resin particles are contained only in the central region, it is presumed that the difference in glossiness conditions may be reduced.

The content of the specific resin particles with respect to the total amount of the toner particles is, for example, preferably 2% by mass or more and 30% by mass or less, more preferably 5% by mass or more and 25% by mass or less, and even more preferably 8% by mass or more and 20% by mass or less.

In a case where the content of the specific resin particles is within the above-described range, a toner having similar viscoelasticity at a high temperature and a high strain and at a low temperature and a low strain is more likely to be obtained, and the difference in glossiness conditions is further reduced as compared with a case where the content of the specific resin particles is lower than the above-described range. In addition, in a case where the content of the specific resin particles contained in the toner particles is in the above-described range, deterioration of fixability resulting from excessively high elasticity of the toner particles is further suppressed, and excellent fixability is more likely to be obtained as compared with a case where the content of the specific resin particles contained in the toner particles is higher than the above-described range.

### Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Other Additives

Examples of other additives include well-known additives such as a magnetic material, a charge control agent, and inorganic powder. The additives are incorporated into the toner particles as internal additives.

### Relationship of Composition in Toner Particles

Difference (SP value (S)−SP value (R))

A difference between an SP value (S) as a solubility parameter of the specific resin particles and an SP value (R) as a solubility parameter of the binder resin (SP value (S)−SP value (R)) is, for example, preferably −0.32 or more and −0.12 or less.

In a case where the difference (SP value (S)−SP value (R)) is within the above-described range, compared to a case where the difference is lower than the above-described range, the affinity between the specific resin particles and the binder resin, that configure most of the toner particles, is maintained at an appropriate level, and the specific resin particles are easily dispersed in the toner particles in a nearly uniform state. Therefore, the obtained toner is likely to have similar viscoelasticity at a high temperature and a high strain and at a low temperature and a low strain, and the difference in glossiness conditions is reduced. That is, compared to a case where the difference (SP value (S)−SP value (R)) is less than the above-described range, since the affinity between the binder resin and the specific resin particles is too high and the specific resin particles move easily in the toner particles, it is difficult for the specific resin particles to partially aggregate and reduce the effect of the specific resin particles.

In addition, in a case where the difference (SP value (S)−SP value (R)) is within the above-described range, compared to a case where the difference is more than the above-described range, excessive mixing or compatibility between the specific resin particles and the binder resin occurs during melting the toner, and an increase in melt viscosity of the toner as a whole is suppressed. As a result, deterioration of fixability resulting from excessively high viscoelasticity is suppressed, which brings an advantage of being capable of obtaining excellent fixability.

In a case where the binder resin is a mixed resin, a solubility parameter of a resin contained in the binder resin at the highest content ratio is adopted as the SP value (R).

The difference (SP value (S)−SP value (R)) is, for example, more preferably −0.32 or more and −0.12 or less, and even more preferably −0.29 or more and −0.18 or less.

The SP value (S) as the solubility parameter of the specific resin particles is, for example, preferably 9.00 or more and 9.15 or less, more preferably 9.03 or more and 9.12 or less, and even more preferably 9.06 or more and 9.10 or less.

Here, the SP value (S) as the solubility parameter of the specific resin particles and the SP value (R) as the solubility parameter of the binder resin (unit: (cal/cm³)^{1/2}) are calculated by Okitsu method. Details of the Okitsu method are described in “Journal of the Adhesion Society of Japan, Vol. 29, No. 5 (1993)”.

### Viscoelasticity of Components (Extra Components) Excluding Specific Resin Particles

For example, it is preferable that a storage elastic modulus G′ of components of the toner particles, excluding the specific resin particles, is 1×10⁸ Pa or more in a range of 30° C. or higher and 50° C. or lower, and that a temperature at which the storage elastic modulus G′ reaches less than 1×10⁵ Pa is 65° C. or higher and 90° C. or lower. Hereinafter, the components of the toner particles, excluding the specific resin particles, are referred to as “extra components”, and a temperature at which the storage elastic modulus G′ reaches less than 1×10⁵ Pa is referred to as a “specific elastic modulus reached temperature”. The extra components having the storage elastic modulus G′ satisfying the above-described conditions have a high elastic modulus at a low temperature and a low elastic modulus at a temperature of 65° C. or higher and 90° C. or lower. Therefore, in a case where the storage elastic modulus G′ of the extra components satisfies the above-described conditions, the toner particles are more easily melted by heating, and better fixability is obtained as compared with a case where the temperature at which the storage elastic modulus G′ of the extra components reaches a value less than 1×10⁵ Pa is higher than 90° C.

The storage elastic modulus G′ of the extra components at 30° C. or higher and 50° C. or lower is, for example, preferably 1×10⁸ Pa or more, more preferably 1×10⁸ Pa or more and 1×10⁹ Pa or less, and even more preferably 2×10⁸ Pa or more and 6×10⁸ Pa or less.

In a case where the storage elastic modulus G′ of the extra components in a range of 30° C. or higher and 50° C. or lower is within the above-described range, the storage stability of the toner is further improved as compared with in a case where the storage elastic modulus G′ of the extra components in a range of 30° C. or higher and 50° C. is lower than the above-described range, and better fixability is likely to be obtained as compared with a case where the storage elastic modulus G′ of the extra components in a range of 30° C. or higher and 50° C. is higher than the above-described range.

In addition, the specific elastic modulus reached temperature of the extra components is, for example, preferably 65° C. or higher and 90° C. or lower, more preferably 68° C. or higher and 80° C. or lower, and even more preferably 70° C. or higher and 75° C. or lower.

In a case where the specific elastic modulus reached temperature of the extra components is within the above-described range, the storage stability of the toner is further improved than in a case where the specific elastic modulus reached temperature of the extra component is lower than the above-described range, and the obtained fixability is likely to be better than in a case where the specific elastic modulus reached temperature of the extra component is higher than the above-described range.

A loss tangent tan δ of the extra components at the specific elastic modulus reached temperature is, for example, preferably 0.8 or more and 1.6 or less, more preferably 0.9 or more and 1.5 or less, and even more preferably 1.0 or more and 1.4 or less.

In a case where the loss tangent tan δ of the extra components at the specific elastic modulus reached temperature is within the above-described range, better fixability is likely to be obtained as compared with a case where the loss tangent tan δ of the extra components at the specific elastic modulus reached temperature is lower than the above-described range. In addition, in a case where the loss tangent tan δ of the extra components at the specific elastic modulus reached temperature is within the above-described range, the difference in glossiness conditions is further reduced as compared with a case where the loss tangent tan δ of the extra components at the specific elastic modulus reached temperature is higher than the above-described range.

The storage elastic modulus G′ and the loss tangent tan δ of the extra components are determined as follows.

Specifically, first, only the extra components excluding the resin particles are isolated from the toner particles and molded into tablets at 25° C. by a press molding machine, thereby producing a measurement sample. Examples of a method of isolating only the extra components excluding the resin particles from the toner particles include a method of immersing the toner particles in a solvent that dissolves the binder resin and does not dissolve the resin particles and isolating the extra components by extraction.

The obtained measurement sample is interposed between parallel plates having a diameter of 8 mm, and dynamic viscoelasticity is measured under the following conditions by raising the measurement temperature from 30° C. to 150° C. at 2° C./min at a strain of 0.1% to 100%. From each of the storage elastic modulus curve and the loss elastic modulus curve obtained by the measurement, the storage elastic modulus G′ and the loss tangent tan δ are determined.
Measurement Conditions
Measurement device: rheometer ARES-G2 (manufactured by TA Instruments)
Fixture: 8 mm parallel plates
Gap: adjusted to 3 mm
Frequency: 1 Hz
Relationship between Specific Resin Particles, Toner Particles, and Extra Components

In a case where the storage elastic modulus of the specific resin particles in a range of 90° C. or higher and 150° C. or lower is represented by G′ (p90-150), the storage elastic modulus of the toner particles in a range of 90° C. or higher and 150° C. or lower is represented by G′ (t90-150), and the storage elastic modulus of the components of the toner particles, excluding the specific resin particles, in a range of 90° C. or higher and 150° C. or lower is represented by G′ (r90-150), for example, it is preferable that G′ (p90-150) is 1×10⁴ Pa or more and 1×10⁶ Pa or less, and log G′ (t90-150)−log G′ (r90-150) is 1.0 or more and 4.0 or less. In addition, the value of log G′ (t90-150)−log G′ (r90-150) is, for example, more preferably 1.0 or more and 3.5 or less, even more preferably 1.1 or more and 3.4 or less, and particularly preferably 1.2 or more and 3.3 or less.

The value of log G′ (t90-150)−log G′ (r90-150) means a difference in viscoelasticity of the toner particles depending on whether or not the specific resin particles are added. By dispersing and encapsulating the specific resin particles in the toner particles in a nearly uniform state, the influence of the viscoelasticity of the specific resin particles on the viscoelasticity of the toner particles as a whole is suppressed. In addition, by controlling the value of log G′ (t90-150)−log G′ (r90-150) to be the above-described range, compared to a case of being lower than or higher than the above-described range, both good fixability and reduction in difference in glossiness conditions are achieved.

### Characteristics of Toner Particles and the Like

The toner particles may be toner particles that have a single-layer structure or toner particles having a so-called core/shell structure that is configured with a core portion (core particle) and a coating layer (shell layer) coating the core portion.

The toner particles having a core/shell structure may, for example, be configured with a core portion that is configured with the binder resin, the specific resin particles, and other additives used as necessary, such as a colorant and a release agent, and a coating layer that is configured with the binder resin and the specific resin particles.

In a case where the toner particles have a core/shell structure, for example, it is preferable that both the core particles and the shell layer contain the specific resin particles. In a case where both the core particles and the shell layer contain the specific resin particles, since both the surface region and the central region of the toner particles contain the specific resin particles, the difference in glossiness conditions is further reduced.

A volume-average particle size (D50v) of the toner particles is, for example, preferably 2 μm or more and 10 μm or less, more preferably 4 μm or more and 8 μm or less, and even more preferably 4 μm or more and 6 μm or less.

The various average particle sizes and various particle size distribution indexes of the toner particles are measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-based particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-based particle size D84v and a number-based particle size D84p.

By using these, a volume-average particle size distribution index (GSDv) is calculated as (D84v/D16v)^{1/2}, and a number-average particle size distribution index (GSDp) is calculated as (D84p/D16p)^{1/2}.

The average circularity of the toner particles is, for example, preferably 0.94 or more and 1.00 or less, and more preferably 0.95 or more and 0.98 or less.

The average circularity of the toner particles is determined by (equivalent circular perimeter)/(perimeter) [(perimeter of circle having the same projected area as particle image)/(perimeter of projected particle image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains the external additive, the toner (developer) as a measurement target is dispersed in water containing a surfactant, then the dispersion is treated with ultrasonic waves such that the external additive is removed, and the toner particles are collected.

### Number-Average Molecular Weight of Tetrahydrofuran-Soluble Components

The number-average molecular weight of the tetrahydrofuran-soluble components in the toner particles is, for example, more preferably 5,000 or more and 15,000 or less.

Hereinafter, the tetrahydrofuran-soluble components are also referred to as “THF-soluble components”.

In a case where the number-average molecular weight of the THF-soluble components in the toner particles is 5,000 or more and 15,000 or less, the change in loss tangent with respect to the change in strain is small, and even in a highly viscous elastic toner in which the extent of deformation is suppressed, a high fixability is obtained. Specifically, by setting the number-average molecular weight of the THF-soluble components to the above-described range, compared to a case of being too small, due to the large amount of low-molecular-weight components in the toner particles, the extent of deformation of the toner particles increases under a high-temperature and a high-pressure fixing condition, so that an increase in difference in glossiness is suppressed. In addition, by setting the number-average molecular weight of the THF-soluble components to the above-described range, compared to a case of being too large, due to the large amount of high-molecular-weight components in the toner particles, the extent of deformation of the toner particles is suppressed, and the difficulty in obtaining low-temperature fixability is suppressed. The number-average molecular weight of the THF-soluble components is, for example, even more preferably 7,000 or more and 10,000 or less.

The number-average molecular weight of the THF-soluble components in the above-described toner particles is measured by preparing THF-soluble components of the toner particles using two “HLC-8120GPC, SC-8020 (6.0 mmID×15 cm, manufactured by Tosoh Corporation)” and tetrahydrofuran (THF) as an eluent.

Specifically, 0.5 mg of the toner particles to be measured are dissolved in 1 g of THF, and after ultrasonic dispersion is applied, a sample is produced by adjusting a concentration to 0.5% by mass.

The measurement is performed using an RI detector under the conditions of a sample concentration of 0.5% by mass, a flow rate of 0.6 ml/min, a sample injection amount of 10 μl, and a measurement temperature of 40° C.

In addition, a calibration curve is created from 10 samples of “Polystyrene standard sample TSK standard” manufactured by Tosoh Corporation: “A-500”, “F-1”, “F-10”, “F-80”, “F-380”, “A-2500”, “F-4”, “F-40”, “F-128”, and “F-700”.

In a case of obtaining the toner particles from an externally added toner, for example, the toner is dispersed in an aqueous solution of 0.2% by mass of polyoxyethylene (10) octylphenyl ether so that the concentration is 10% by mass, and the external additive is liberated by applying ultrasonic vibration (frequency: 20 kHz, output: 30 W) for 60 minutes while maintaining a temperature or 30° C. or lower. The toner particles from which the external additive is removed are obtained by filtering out the toner particles from the obtained dispersion and washing the toner particles.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by immersing the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 5% by mass or less, and more preferably 0.01% by mass or more and 2.0% by mass or less.

### Characteristics of Toner

### Viscoelasticity of Toner

As described above, the toner according to the present exemplary embodiment is the specific toner. That is, all of D1 (90), D50 (90), D1 (150), and D50 (150) are 0.5 or more and 2.5 or less, the value of D50 (150)−D1 (150) is less than 1.5, and the value of D50 (90)−D1 (90) is less than 1.0.

The D1 (90) in the specific toner is 0.5 or more and 2.5 or less, and for example, is preferably 0.5 or more and 2.0 or less, more preferably 0.6 or more and 1.8 or less, even more preferably 0.8 or more and 1.6 or less, and particularly preferably 1.0 or more and 1.5 or less.

The D50 (90) in the specific toner is 0.5 or more and 2.5 or less, and for example, is preferably 0.5 or more and 2.0 or less, more preferably 0.6 or more and 1.8 or less, even more preferably 0.8 or more and 1.6 or less, and particularly preferably 1.1 or more and 1.6 or less.

The D1 (150) in the specific toner is 0.5 or more and 2.5 or less, and for example, is preferably 0.5 or more and 2.0 or less, more preferably 0.5 or more and 1.5 or less, even more preferably 0.55 or more and 1.0 or less, and particularly preferably 0.55 or more and 0.8 or less.

The D50 (150) in the specific toner is 0.5 or more and 2.5 or less, and for example, is preferably 0.8 or more and 2.2 or less, more preferably 1.0 or more and 2.0 or less, even more preferably 1.2 or more and 1.9 or less, and particularly preferably 1.4 or more and 1.7 or less.

In a case where all of D1 (90), D50 (90), D1 (150), and D50 (150) are within the above-described range, the fog of the image is suppressed compared to a case of being lower than or higher than the above-described range. In addition, in a case where all of D1 (90), D50 (90), D1 (150), and D50 (150) are within the above-described range, good fixability is obtained compared to a case of being lower than the above-described range, and the difference in glossiness conditions is reduced compared to a case of being more than the above-described range.

The value of D50 (150)−D1 (150) in the specific toner is less than 1.5, and for example, is preferably 1.2 or less and more preferably 1.0 or less. In a case where the value of D50 (150)−D1 (150) is within the above-described range, the difference in glossiness conditions is reduced compared to a case of being more than the above-described range. From the viewpoint of reducing the difference in glossiness conditions, for example, it is preferable that the value of D50 (150)−D1 (150) is smaller.

The lower limit of the value of D50 (150)−D1 (150) is not particularly limited.

The value of D50 (90)−D1 (90) in the specific toner is less than 1.0, and for example, is preferably less than 0.5, more preferably 0.4 or less, and even more preferably 0.3 or less. In a case where the value of D50 (90)−D1 (90) is within the above-described range, the difference in glossiness conditions is reduced compared to a case of being more than the above-described range. From the viewpoint of reducing the difference in glossiness conditions, for example, it is preferable that the value of D50 (90)−D1 (90) is smaller.

The lower limit of the value of D50 (90)−D1 (90) is not particularly limited.

For example, it is preferable that a storage elastic modulus G′ of the toner is 1×10⁸ Pa or more in a range of 30° C. or higher and 50° C. or lower, and that a temperature at which the storage elastic modulus G′ reaches less than 1×10⁵ Pa (that is, the specific elastic modulus reached temperature) is 65° C. or higher and 90° C. or lower. The toner having the storage elastic modulus G′ satisfying the above-described conditions has a high elastic modulus at a low temperature and a low elastic modulus at a temperature of 65° C. or higher and 90° C. or lower. Therefore, in a case where the storage elastic modulus G′ of the toner satisfies the above-described conditions, the toner is more easily melted by heating, and better fixability is obtained as compared with a case where the temperature at which the storage elastic modulus G′ of the extra components reaches a value less than 1×10⁵ Pa is higher than 90° C.

The storage elastic modulus G′ of the toner at 30° C. or higher and 50° C. or lower is, for example, preferably 1×10⁸ Pa or more, more preferably 1×10⁸ Pa or more and 1×10⁹ Pa or less, and even more preferably 2×10⁸ Pa or more and 6×10⁸ Pa or less.

In a case where the storage elastic modulus G′ of the toner in a range of 30° C. or higher and 50° C. or lower is in the above range, the storage stability of the toner is further improved as compared with a case where the storage elastic modulus G′ of the toner in a range of 30° C. or higher and 50° C. is lower than the above-described range, and better fixability is likely to be obtained as compared with a case where the storage elastic modulus G′ of the toner in a range of 30° C. or higher and 50° C. is higher than the above-described range.

The specific elastic modulus reached temperature of the toner is, for example, preferably 65° C. or higher and 90° C. or lower, more preferably 70° C. or higher and 87° C. or lower, and even more preferably 75° C. or higher and 84° C. or lower.

In a case where the specific elastic modulus reached temperature of the toner is within the above-described range, the storage stability of the toner is further improved than in a case where the specific elastic modulus reached temperature of the extra component is lower than the above-described range, and the obtained fixability is likely to be better than in a case where the specific elastic modulus reached temperature of the toner is higher than the above-described range.

The storage elastic modulus G′ and the specific elastic modulus reached temperature of the toner are determined as follows.

Specifically, by a press molding machine, a toner as a measurement target is molded into tablets at room temperature (25° C.), thereby producing a measurement sample. The obtained measurement sample is interposed between parallel plates having a diameter of 8 mm, and dynamic viscoelasticity is measured under the following conditions by raising the measurement temperature from 30° C. to 150° C. at 2° C./min at a strain of 0.1% to 100%. From each of the storage elastic modulus curve and the loss elastic modulus curve obtained by the measurement, the storage elastic modulus G′ is determined.
Measurement Conditions
Measurement device: rheometer ARES-G2 (manufactured by TA Instruments)
Fixture: 8 mm parallel plates
Gap: adjusted to 3 mm
Frequency: 1 Hz
Manufacturing Method of Toner

Next, the manufacturing method of the toner according to the present exemplary embodiment will be described.

The toner according to the present exemplary embodiment is obtained by manufacturing toner particles and then adding the external additive to the exterior of the toner particles as necessary.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to these manufacturing methods, and a well-known manufacturing method is adopted.

Among the above methods, for example, the aggregation and coalescence method may be used for obtaining toner particles.

Specifically, in a case where the toner particles are manufactured by the aggregation and coalescence method, for example, the toner particles are manufactured through a step of preparing a resin particle dispersion in which resin particles to be the binder resin are dispersed and a specific resin particle dispersion to be the specific resin particles (a resin particle dispersion-preparing step), a step of allowing the resin particles (and other particles as necessary) to be aggregated in the resin particle dispersion (in the dispersion after mixing other particle dispersions as necessary) so as to form aggregated particles (aggregated particle-forming step), and a step of heating an aggregated particle dispersion in which the aggregated particles are dispersed to allow the aggregated particles to undergo coalescence and to form toner particles (coalescence step).

Hereinafter, each of the steps will be specifically described.

In the following section, a method for obtaining toner particles containing a colorant and a release agent will be described. The colorant and the release agent are used as necessary. Naturally, other additives different from the colorant and the release agent may also be used.

### Resin Particle Dispersion-Preparing Step

First, for example, a colorant particle dispersion in which colorant particles are dispersed and a release agent particle dispersion in which release agent particles are dispersed are prepared together with the resin particle dispersion in which resin particles to be a binder resin are dispersed.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 m or more and 0.8 μm or less, and even more preferably 0.1 μm or more and 0.6 μm or less.

For determining the volume-average particle size of the resin particles, a particle size distribution is measured using a laser diffraction type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant particle dispersion and a release agent particle dispersion are prepared in the same manner as that adopted for preparing the resin particle dispersion. That is, the volume-average particle size of the resin particles, the dispersion medium, the dispersion method, and the content of the resin particles in the resin particle dispersion are also applied to the colorant particles to be dispersed in the colorant particle dispersion and the release agent particles to be dispersed in the release agent particle dispersion.

### Preparation of Specific Resin Particle Dispersion

As a method for preparing the specific resin particle dispersion, for example, known methods such as an emulsion polymerization method, a melt-kneading method using a Banbury mixer or a kneader, a suspension polymerization method, and a spray drying method are used.

Among these, for example, an emulsion polymerization method is preferable.

From the viewpoint of maintaining the storage elastic modulus G′ and the loss tangent tan δ of the specific resin particles within the preferred range, for example, it is preferable to use a styrene-based monomer and a (meth)acrylic acid-based monomer as monomers and carry out polymerization in the presence of a crosslinking agent.

Furthermore, in manufacturing the specific resin particles, for example, it is preferable to perform emulsion polymerization a plurality of times.

Hereinafter, a method for manufacturing the specific resin particles will be specifically described.

The method for preparing the specific resin particle dispersion preferably includes, for example,
a step of obtaining an emulsion containing a monomer, a crosslinking agent, a surfactant, and water (emulsion preparation step),
a step of adding a polymerization initiator to the emulsion and heating the emulsion so as to polymerize the monomer (first emulsion polymerization step), and
a step of adding an emulsion containing a monomer and a crosslinking agent to a reaction solution obtained after the first emulsion polymerization step and heating the solution so as to polymerize the monomer (second emulsion polymerization step).

### Emulsion Preparation Step

The emulsion preparation step is a step of obtaining an emulsion containing a monomer, a crosslinking agent, a surfactant, and water.

For example, it is preferable to obtain the emulsion by emulsifying a monomer, a crosslinking agent, a surfactant, and water by using an emulsifying machine.

Examples of the emulsifying machine include a rotary stirrer equipped with a propeller type, anchor type, paddle type, or turbine type stirring blade, a stationary mixer such as a static mixer, and a rotor and stator type emulsifying machine such as a homogenizer or Clare mix, a mill type emulsifying machine having grinding function, a high-pressure emulsifying machine such as a Manton-Gaulin-type pressure emulsifying machine, a high-pressure nozzle type emulsifying machine that causes cavitation under high pressure, a high-pressure impact-type emulsifying machine, such as a microfluidizer, that generates shearing force by causing collision of liquids under high pressure, an ultrasonic emulsifying machine that causes cavitation by using ultrasonic waves, and a membrane emulsifying machine that performs uniform emulsification through pores.

As the monomers, for example, it is preferable to use a styrene-based monomer and a (meth)acrylic acid-based monomer.

As the crosslinking agent, the aforementioned crosslinking agent is used.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. The nonionic surfactant may be used in combination with an anionic surfactant or a cationic surfactant. Among these surfactants, for example, an anionic surfactant is preferable. One kind of surfactant may be used alone, or two or more kinds of surfactants may be used in combination.

The emulsion may contain a chain transfer agent. The chain transfer agent is not particularly limited. As the chain transfer agent, a compound having a thiol component can be used. Specifically, for example, alkyl mercaptans such as hexyl mercaptan, heptyl mercaptan, octyl mercaptan, nonyl mercaptan, decyl mercaptan, and dodecyl mercaptan are preferable.

From the viewpoint of maintaining the storage elastic modulus G′ and the loss tangent tan δ of the specific resin particles within the preferred range, a mass ratio of the styrene-based monomer to the (meth)acrylic acid-based monomer in the emulsion (styrene-based monomer/(meth)acrylic acid-based monomer) is, for example, preferably 0.2 or more and 1.1 or less.

In addition, from the viewpoint of setting the storage elastic modulus G′ and the loss tangent tan δ of the specific resin particles to be within, for example, the preferred ranges, a content of the crosslinking agent is, for example, preferably 0.5% by mass or more and 3% by mass or less with respect to the total mass of the emulsion.

### First Emulsion Polymerization Step

This is a step of adding a polymerization initiator to the emulsion and heating the emulsion so as to polymerize the monomers.

Here, in the polymerization, for example, it is preferable to stir the emulsion (reaction solution) containing the polymerization initiator with a stirrer.

Examples of the stirrer include a rotary stirrer equipped with a propeller type, anchor type, paddle type, or turbine type stirring blade.

As the polymerization initiator, for example, it is preferable to use ammonium persulfate.

In a case where a polymerization initiator is used, the amount of the polymerization initiator added may be adjusted so that the viscoelasticity of the obtained specific resin particles is controlled. For example, by reducing the amount of the polymerization initiator added, it is easy to obtain resin particles having a high storage elastic modulus G′.

### Second Emulsion Polymerization Step

The step is adding an emulsion containing a monomer to the reaction solution obtained after the first emulsion polymerization step, and heating to polymerize the monomer.

In the polymerization, for example, it is preferable to stir the reaction solution in the same manner as in the first emulsion polymerization step.

In this step, the time required for adding the emulsion containing the monomers may be adjusted so that the viscoelasticity of the obtained specific resin particles is controlled. For example, by increasing the time required for adding the emulsion containing the monomer, it is easy to obtain resin particles having a high storage elastic modulus G′. The time required for adding the emulsion containing the monomer is, for example, in a range of 2 hours or more and 5 hours or less.

Furthermore, in this step, the temperature at which the reaction solution is stirred may be adjusted so that the viscoelasticity of the obtained specific resin particles is controlled. For example, by reducing the temperature at which the reaction solution is stirred, it is easy to obtain resin particles having a high storage elastic modulus G′. The temperature at which the reaction solution is stirred is, for example, in a range of 55° C. or higher and 75° C. or lower.

For example, it is preferable to obtain the emulsion containing monomers by emulsifying monomers, a surfactant, and water by using an emulsifying machine.

### Aggregated Particle-Forming Step

Next, the colorant particle dispersion, the release agent particle dispersion, and the specific resin particle dispersion are mixed together with the resin particle dispersion.

Thereafter, in the mixed dispersion, the resin particles, the colorant particles, the release agent particles, and the specific resin particles are hetero-aggregated such that aggregated particles are formed which have a diameter close to the diameter of the target toner particles and include the resin particles, the colorant particles, the release agent particles, and the specific resin particles.

Specifically, for example, an aggregating agent is added to the mixed dispersion, the pH of the mixed dispersion is adjusted such that the dispersion is acidic (for example, pH of 2 or higher and 5 or lower), and a dispersion stabilizer is added thereto as necessary. Thereafter, the dispersion is heated to a temperature of the glass transition temperature of the resin particles (specifically, for example, to a temperature equal to or higher than the glass transition temperature of the resin particles −30° C. and equal to or lower than the glass transition temperature of the resin particles −10° C.) such that the particles dispersed in the mixed dispersion are aggregated, thereby forming aggregated particles.

In the aggregated particle-forming step, for example, in a state where the mixed dispersion is stirred with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

In this step, by adjusting the temperature of the mixed dispersion in a case of adding the aggregating agent, the dispersion state of the specific resin particles in the obtained toner particles may be controlled. For example, by reducing the temperature of the mixed dispersion, the dispersibility of the specific resin particles is good. The temperature of the mixed dispersion is, for example, in a range of 5° C. or higher and 40° C. or lower.

In addition, in this step, by adjusting the stirring rate after adding the aggregating agent, the dispersion state of the specific resin particles in the obtained toner particles may be controlled. For example, by increasing the stirring rate after adding the aggregating agent, the dispersibility of the specific resin particles is good.

Examples of the aggregating agent include a surfactant having polarity opposite to the polarity of the surfactant used as a dispersant added to the mixed dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added with respect to 100 parts by mass of resin particles is, for example, preferably 0.01 parts by mass or more and 5.0 parts by mass or less, and more preferably 0.1 parts by mass or more and less than 3.0 parts by mass.

### Coalescence Step

The aggregated particle dispersion in which the aggregated particles are dispersed is then heated to, for example, a temperature equal to or higher than the glass transition temperature of the resin particles (for example, a temperature higher than the glass transition temperature of the resin particles by 10° C. to 30° C.) such that the aggregated particles coalesce, thereby forming toner particles.

Toner particles are obtained through the above steps.

The toner particles may be manufactured through a step of obtaining an aggregated particle dispersion in which the aggregated particles are dispersed, then mixing the aggregated particle dispersion with a resin particle dispersion in which resin particles are dispersed and the specific resin particle dispersion in which the specific resin particles are dispersed so as to cause the resin particles and the specific resin particles to be aggregated and adhere to the surface of the aggregated particles and to form second aggregated particles, and a step of heating a second aggregated particle dispersion in which the second aggregated particles are dispersed so as to cause the second aggregated particles to be coalesced and to form toner particles having a core/shell structure.

In the step of forming second aggregated particles, the addition of the resin particle dispersion and the specific resin particle dispersion and the adhesion of the resin particles and the specific resin particles to the surface of the aggregated particles may be repeated a plurality of times. In a case where the operations are repeated a plurality of times, toner particles are obtained in which the specific resin particles are evenly incorporated into both the surface region and the central region of the toner particles.

After the coalescence step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, by adding an external additive to the obtained dry toner particles and mixing the external additive and the toner particles together, the toner according to the present exemplary embodiment is manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

### Carrier

A form of the first specific carrier is not particularly limited, and examples thereof include a carrier containing core particles and a resin layer that coats a surface of the core particles.

The core particles are not particularly limited, and known magnetic particles used as a core material of the carrier are applied. Specific examples of the core particles include particles of a magnetic metal such as iron, nickel, and cobalt; particles of a magnetic oxide such as ferrite and magnetite; resin-impregnated magnetic particles in which a porous magnetic powder is impregnated with a resin; and magnetic powder-dispersed resin particles in which a magnetic powder is dispersed in a resin. From the viewpoint of easily controlling the true specific gravity within the above-described range, the core particles are, for example, preferably magnetic powder-dispersed resin particles.

The second specific carrier contains core particles that are magnetic powder-dispersed resin particles in which a magnetic powder is dispersed in a resin. The second specific carrier may contain the above-described core particles and a resin layer that coats a surface of the core particles.

Hereinafter, as an example of the carrier used in the present exemplary embodiment, a carrier containing core particles that are the magnetic powder-dispersed resin particles and a resin layer that coats a surface of the core particles will be described.

### Core Particles

The core particles that are the magnetic powder-dispersed resin particles contain a magnetic powder and a resin.

The magnetic powder is not particularly limited, and any known magnetic powder in the related art may be used. Specific examples thereof include γ-iron oxide, ferrite, and magnetite. From the viewpoint of excellent stability, for example, it is preferable to use ferrite or magnetite, and from the viewpoint of low cost, for example, it is preferable to use magnetite.

Examples of the ferrite include ferrite particles represented by the following structural formula.

Structural formula:(MO)_{X}(Fe₂O₃)_{Y}
(in the structural formula, M represents at least one metal element selected from Cu, Zn, Fe, Mg, Mn, Ca, Li, Ti, Ni, Sn, Sr, Al, Ba, Co, or Mo, and X and Y represent a molar ratio and satisfy X+Y=100)

As the ferrite, among the structures represented by the above structural formula, examples of a structure in which M is represented by a plurality of metal elements include iron-based oxides such as Mn—Zn ferrite, Ni—Zn ferrite, Mn—Mg ferrite, Li ferrite, and Cu—Zn ferrite.

From the viewpoint of increasing a filling rate of the magnetic powder in the core particles and easily controlling the specific gravity of the core particles, a volume-average particle size of the magnetic powder is, for example, 0.01 μm or more and 1 μm or less, more preferably 0.03 μm or more and 0.5 m or less, and particularly preferably 0.05 μm or more and 0.35 μm or less.

Volume-average particle sizes of the magnetic powder and core particles in the present exemplary embodiment, the core material in which a thin film layer described later is formed on the surface of the core particles, and the carrier are values measured by a laser diffraction type particle size distribution analyzer LA-700 (manufactured by HORIBA, Ltd.). Specifically, for the particle size range (channel) divided using a particle size distribution obtained by the measurement device, a cumulative volume distribution is plotted from the small-sized particles, and the particle size at which the cumulative percentage of the particles reaches 50% is adopted as the volume-average particle size.

In addition, examples of a method of removing a resin coating layer from the carrier include a method of dissolving the resin coating layer with an organic solvent to separate the core particles or core material.

In addition, as the method of removing a resin coating layer from the carrier, for example, the following method can be mentioned.

20 g of the carrier is added to 100 mL of toluene. An ultrasonic wave is applied thereto for 30 seconds under the condition of 40 kHz. The core particles or core material and the resin solution are separated by using an arbitrary filter paper according to the particle size. The core particles or core material remaining on the filter paper are washed by pouring 20 mL of toluene from above. Next, the core particles or core material remaining on the filter paper are collected. Similarly, the collected core particles or core material are put into 100 mL of toluene, and an ultrasonic wave is applied thereto for 30 seconds under the condition of 40 kHz. The core particles or core material are filtered in the same manner, washed with 20 mL of toluene, and then collected. This process is performed 10 times. Finally, the collected core particles or core material are dried.

In addition, from the viewpoint of setting the content of the magnetic powder with respect to the total amount of the carrier to be more than 80% by mass and less than 90% by mass, or from the viewpoint of setting the true specific gravity of the entire carrier to be 3.0 g/cm³ or more and 4.0 g/cm³ or less, a content of the magnetic powder in the core particles is, for example, more than 80% by mass and 95% by mass or less, more preferably more than 80% by mass and 90% by mass or less, and particularly preferably 82% by mass or more and 85% by mass or less.

The resin constituting the core particles may be either a thermoplastic resin or a thermosetting resin, and examples thereof include resins such as a vinyl resin, a polyester resin, an epoxy resin, a phenol resin, a urea resin, a polyurethane resin, a polyimide resin, a cellulose resin, a silicone resin, an acrylic resin, and a polyether resin. The resin may be one kind or a mixed resin of two or more kinds.

Examples of the phenol resin include resins obtained by reacting phenol with formaldehyde. The core particles containing the phenol resin as the resin are obtained, for example, by reacting ferromagnetic iron compound particles, non-magnetic iron compound particles, phenols, and aldehydes in an aqueous medium in the presence of a basic catalyst.

Examples of the phenols include phenol; alkylphenols such as m-cresol, p-tert-butylphenol, o-propylphenol, resorcinol, and bisphenol A; compounds having a phenolic hydroxyl group, such as halogenated phenols in which a benzene nucleus or a part or all of alkyl groups are substituted with a chlorine atom or a bromine atom, and among the phenols, for example, phenol is particularly preferable.

Examples of the aldehydes include formaldehyde and paraformaldehyde.

A molar ratio of the aldehydes to the phenols is, for example, preferably 1 to 2, and particularly preferably 1.1 to 1.6. In a case where the molar ratio of the aldehydes to the phenols is smaller than 1, it is difficult to generate spherical composite particles, and even in a case where the spherical composite particles are generated, the strength of the generated particles tends to be weak because the curing of the resin is difficult to proceed. On the other hand, in a case where the molar ratio of the aldehydes to the phenols is larger than 2, the amount of unreacted aldehydes remaining in the aqueous medium after the reaction tends to increase.

Examples of the basic catalyst used in the present exemplary embodiment include catalysts used in ordinary production of a resol resin, for example, aqueous ammonia, hexamethylenetetramine, and alkylamines such as dimethylamine, diethyltriamine, and polyethyleneimine. A molar ratio of these basic catalysts to the phenols is, for example, preferably 0.02 or more and 0.3 or less.

In the reaction of the phenols and the aldehydes in the presence of a basic catalyst, amounts of the ferromagnetic iron compound particles and the non-magnetic iron compound particles coexisting is, for example, preferably 0.5 times or more and 200 times or less the weight of the phenols. Furthermore, in consideration of the strength of the spherical composite particles to be generated, the amounts of the ferromagnetic iron compound particles and the non-magnetic iron compound particles coexisting is, for example, more preferably 4 times or more and 100 times or less.

For example, preferred examples of the vinyl resin include a vinyl ether resin and an N-vinyl resin. Among these resins, as the vinyl resin, from the viewpoint of binding property, for example, a vinyl ether resin is preferable.

Among the above resins in the core particles, from the viewpoint of both suppression of carrier deformation and charge retention performance, for example, it is preferable to contain the phenol resin, it is more preferable to contain the phenol resin in an amount of 50% by mass or more with respect to the total mass of resins in the core particles, and it is particularly preferable to contain the phenol resin in an amount of 80% by mass or more with respect to the total mass of resins in the core particles.

In addition, the above-described core particles may further contain other components depending on the intended purpose. Examples of the other components include a charge control agent and fluorine-containing particles.

A method for manufacturing the above-described core particles is not particularly limited, and examples thereof include a melt-kneading method in which the magnetic powder and the resin described above are melt-kneaded using a Banbury mixer, a kneader, or the like, cooled, pulverized, and classified (JP1984-24416B, JP1996-3679B, and the like); a suspension polymerization method in which monomer units of the binder resin and the magnetic powder are dispersed in a solvent to prepare a suspension, and the suspension is polymerized (JP1993-100493A and the like); and a spray drying method in which the magnetic powder is mixed and dispersed in a resin solution, and then spray-dried.

In all of the above-described melt-kneading method, suspension polymerization method, and spray drying method, a step of preparing the magnetic powder in advance by some method, mixing the magnetic powder with the resin, a monomer solution of the resin, or the resin solution, and dispersing the magnetic powder in the resin is included.

As for a magnetic force of the core particles, a saturation magnetization of the core particles in a magnetic field of 3,000 Oe is, for example, preferably 50 emu/g or more, and more preferably 60 emu/g or more. The saturation magnetization is measured using a vibrating sample magnetometer VSMP10-15 (manufactured by TOEI INDUSTRY CO., LTD.). The measurement sample is packed in a cell having an inner diameter of 7 mm and a height of 5 mm and set in the aforementioned magnetometer. For the measurement, a magnetic field is applied and swept up to 3,000 Oe. Next, the applied magnetic field is reduced, and a hysteresis curve is created on recording paper. Saturation magnetization, residual magnetization, and coercive force are obtained from the data of the curve.

An electrical volume resistance (volume resistivity) of the core particles is, for example, preferably 1×10⁵ Ω·cm or more and 1×10⁹ Ω·cm or less, and more preferably 1×10⁷ Ω·cm or more and 1×10⁹ Ω·cm or less.

The electrical volume resistance (Ω·cm) of the core particles is measured as follows.

A measurement target is placed flat on the surface of a circular jig on which a 20 cm² electrode plate is disposed, such that the measurement target has a thickness of approximately 1 mm or more and 3 mm or less and forms a layer. The above-described 20 cm² electrode plate is placed on the layer such that the layer is sandwiched between the electrode plates. In order to eliminate voids between measurement targets, a load of 4 kg is applied onto the electrode plates arranged on the layer, and then the thickness (cm) of the layer is measured. Both the upper and lower electrodes of the layer are connected to an electrometer and a high-voltage power supply device. A high voltage is applied to both electrodes such that an electric field of 10^{3.8} V/cm is generated, and the current value (A) flowing at this time is read. The volume resistivity is measured in an environment at a temperature of 20° C. and a relative humidity of 50%. An expression for calculating the electrical volume resistance (Ω·cm) of the measurement target is as follows.

$$R = E \times 20 / ( I - {I}_{0} ) / L$$

In the above expression, R represents an electrical volume resistance (Ω·cm) of the measurement target, E represents an applied voltage (V), I represents a current value (A), I₀ represents a current value (A) at an applied voltage of 0 V, and L represents a thickness of the layer (cm). The coefficient of 20 represents an area (cm²) of the electrode plate.

From the viewpoint of suppressing the external additive embedding in the toner and ensuring the fluidity of the carrier, a volume-average particle size of the core particles is, for example, preferably 25 μm or more and 40 μm or less, more preferably 25 μm or more and 38 μm or less, and particularly preferably 28 μm or more and 36 μm or less.

### Resin Layer

The resin layer is a layer that coats the surface of the core particles and contains a resin. The resin layer may be a layer that coats at least a part of the surface of the magnetic particles. The resin layer may be only one layer or two or may be two or more layers.

For example, it is preferable that the resin layer includes a first resin layer that coats a surface of the core particles, and a second resin layer that coats an outer peripheral surface of the first resin layer. The second resin layer is a layer containing a resin different from the resin contained in the first resin layer. In a case where the resin layer includes the first resin layer and the second resin layer, the fog of the image is suppressed. It is presumed that the reason is that charging stability of the carrier is improved by including the first resin layer and the second resin layer in the resin layer. Specifically, for example, a local charge leak occurs in the carrier under high temperature and high humidity, so that the charge of the carrier is unstable and the fog may easily occur. In the carrier in which the resin layer includes the first resin layer and the second resin layer, it is presumed that the fog is suppressed by making the above-described local charge leak less likely to occur.

The resin layer may include a resin layer other than the first resin layer and the second resin layer. The first resin layer is, for example, preferably a layer provided in contact with the core particles. The second resin layer is, for example, preferably an outermost layer. For example, it is preferable that the resin layer is composed of the first resin layer and the second resin layer. Hereinafter, the first resin layer is also referred to as a thin film layer, and the second resin layer is also referred to as a resin coating layer.

Each of the thin film layer and the resin coating layer is described below.

In a case where the resin layer is composed of only one layer, examples of the resin layer include the same layer as the resin coating layer described later.

Thin Film layer

The thin film layer is a layer provided between the core particles and the resin coating layer. The thin film layer is not particularly limited as long as the thin film layer is a layer containing a resin different from the resin of the resin coating layer.

Examples of the resin constituting the thin film layer include a melamine resin, a urethane resin, a urea resin, an epoxy resin, and a polyester resin.

From the viewpoint of suppressing the fog of the image, for example, the thin film layer preferably contains at least one selected from the group consisting of a melamine resin, a urethane resin, and a urea resin, and more preferably contains a melamine resin. In a case where the thin film layer contains a melamine resin, it is presumed that the melamine resin contained in the thin film layer functions as a charging property imparting agent, and the toner is easily charged, thereby suppressing the fog.

The thin film layer may contain a component other than the resin. Examples of other components include a charge control agent such as an amine compound and a carboxylic acid compound; and a conductive agent such as carbon black and tin oxide. A content of the resin with respect to the total amount of the thin film layer is, for example, preferably 80% by mass or more, more preferably 90% by mass or more, and even more preferably 95% by mass or more.

Examples of a method of forming the thin film layer on the surface of the core particles include a wet manufacturing method and a dry manufacturing method. The wet manufacturing method is a manufacturing method using a solvent that dissolves or disperses the resin configuring the resin coating layer. On the other hand, the dry manufacturing method is a manufacturing method that does not use the above-described solvent.

Examples of the wet manufacturing method include an immersing method in which the core particles are immersed in a resin solution for forming the thin film layer to coat the core particles. Examples of the dry manufacturing method include a method of heating a mixture of the core particles and a resin for forming a thin film layer in a dry state to form the thin film layer.

In a case where the thin film layer containing the melamine resin is formed on the surface of the core particles, for example, the wet manufacturing method is preferably used. Specifically, the core particles are added to a solution containing melamine, formarin, and a solvent, and the mixture is stirred and heated to obtain core particles on which the thin film layer containing the melamine resin is formed. Examples of the above-described solvent include deionized water.

From the viewpoint of charge retention and carrier resistance, an average thickness of the thin film layer is, for example, preferably 0.05 μm or more and 1.50 μm or less, more preferably 0.10 μm or more and 1.00 μm or less, and particularly preferably 0.10 μm or more and 0.60 μm or less.

The average thickness of the thin film layer and the average thickness of the resin coating layer described later are obtained by the following method.

The carrier is embedded in an epoxy resin, and cut with a microtome to produce a carrier cross section. An SEM image obtained by imaging the carrier cross section with a scanning electron microscope (SEM) is incorporated into an image processing analysis apparatus, and image analysis is performed. A thickness (μm) of the thin film layer or the resin coating layer is measured by randomly selecting 10 sites per one carrier particle, thicknesses of 100 carriers are further measured, and all thicknesses are arithmetically averaged to obtain a value as the average thickness (μm) of the thin film layer and the average thickness (μm) of the resin coating layer.

From the viewpoint of suppressing the external additive embedding in the toner and ensuring the fluidity of the carrier, a volume-average particle size of the core material in which the thin film layer is formed on the core particles is, for example, preferably 25 μm or more and 40 μm or less, more preferably 25 μm or more and 38 μm or less, and particularly preferably 28 μm or more and 36 μm or less.

From the viewpoint of setting the content of the magnetic powder with respect to the total amount of the carrier to be more than 80% by mass and less than 90% by mass, or from the viewpoint of setting the true specific gravity of the entire carrier to be 3.0 g/cm³ or more and 4.0 g/cm³ or less, a content of the magnetic powder with respect to the total amount of the core material in which the thin film layer is formed on the core particles is, for example, more than 80% by mass and 90% by mass or less, more preferably 82% by mass or more and 87% by mass or less, and particularly preferably 83% by mass or more and 85% by mass or less.

### Resin Coating Layer

The resin coating layer is a layer provided on an outer peripheral surface of the thin film layer. The resin coating layer is not particularly limited as long as the resin coating layer is a layer containing a resin different from the resin of the thin film layer.

Examples of the resin configuring the resin coating layer include a styrene acrylic acid copolymer; a polyolefin-based resin such as polyethylene or polypropylene; a polyvinyl-based or polyvinylidene-based resins such as polystyrene, an acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof, a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

Among the resins, as the resin configuring the resin coating layer, from the viewpoint of charging properties and external additive adhesion controllability, for example, it is preferable to contain an acrylic resin, it is more preferable to contain an acrylic resin in an amount of 50% by mass or more with respect to the total mass of resins in the resin coating layer, and it is particularly preferable to contain an acrylic resin in an amount of 80% by mass or more with respect to the total mass of resins in the resin coating layer.

From the viewpoint of suppressing electrification fluctuations due to temperature and humidity, for example, the resin coating layer preferably contains an acrylic resin having an alicyclic structure. As a polymerization component of the acrylic resin having an alicyclic structure, for example, a lower alkyl ester of (meth)acrylic acid (for example, a (meth)acrylic acid alkyl ester having an alkyl group having 1 or more and 9 or less carbon atoms) is preferable, and specific examples thereof include methyl (meth)acrylate, ethyl (meth)acrylate, propyl (meth)acrylate, butyl (meth)acrylate, hexyl (meth)acrylate, cyclohexyl (meth)acrylate, and 2-ethylhexyl (meth)acrylate. The monomers may be used alone or in combination of two or more.

For example, the acrylic resin having an alicyclic structure preferably includes, as the polymerization component, cyclohexyl (meth)acrylate. With respect to the total mass of the acrylic resin having an alicyclic structure, a content of a monomer unit derived from the cyclohexyl (meth)acrylate included in the acrylic resin having an alicyclic structure is, for example, preferably 75% by mass or more and 100% by mass or less, more preferably 85% by mass or more and 100% by mass or less, and even more preferably 95% by mass or more and 100% by mass or less.

A weight-average molecular weight of the resin contained in the resin coating layer is, for example, preferably less than 300,000, more preferably less than 250,000, even more preferably 5,000 or more and less than 250,000, and particularly preferably 10,000 or more and 200,000 or less. Within the above-described range, for example, wetting with the core material is suitable, and a resin coating layer having a uniform film thickness can be obtained.

For the purpose of controlling charging and resistance, the resin coating layer may contain conductive particles. Examples of the conductive particles include carbon black, metals such as gold, silver, and copper, and particles such as carbon black, titanium oxide, zinc oxide, tin oxide, barium sulfate, aluminum borate, and potassium titanate.

Examples of a method of forming the resin coating layer on the outer peripheral surface of the thin film layer include a wet manufacturing method and a dry manufacturing method.

The wet manufacturing method is a manufacturing method using a solvent that dissolves or disperses the resin configuring the resin coating layer. On the other hand, the dry manufacturing method is a manufacturing method that does not use the above-described solvent.

Specifically, examples of the wet manufacturing method include an immersion method of immersing the core particles on which the thin film layer has been formed in a resin solution for forming a resin coating layer; a spray method of spraying the resin solution for forming a resin coating layer to the outer peripheral surface of the thin film layer; a fluidized bed method of spraying the resin solution for forming a resin coating layer to the core particles on which the thin film layer has been formed, that are in a state of being fluidized in a fluidized bed; and a kneader coater method of mixing the core particles on which the thin film layer has been formed with the resin solution for forming a resin coating layer in a kneader coater and removing solvents. The manufacturing methods may be repeated or combined.

The resin solution for forming the resin coating layer used in the wet manufacturing method is prepared by dissolving or dispersing a resin and other components in a solvent. The solvent is not particularly limited, and for example, aromatic hydrocarbons such as toluene and xylene; ketones such as acetone and methyl ethyl ketone; ethers such as tetrahydrofuran and dioxane; and the like are used.

Examples of the dry manufacturing method include a method of heating a mixture of the core particles on which the thin film layer has been formed and a resin for forming a resin coating layer in a dry state to form the resin coating layer. Specifically, for example, the core particles on which the thin film layer has formed and the resin for forming a resin coating layer are mixed together in a gas phase and melted by heating to form the resin coating layer.

From the viewpoint of resistance change suppression against temperature and humidity, an average thickness of the resin coating layer is, for example, preferably 0.6 μm or more and 1.4 μm or less, more preferably 0.8 μm or more and 1.2 μm or less, and particularly preferably 0.8 μm or more and 1.1 μm or less.

### Characteristics of Carrier

From the viewpoint of suppressing the external additive embedding in the toner and ensuring the fluidity of the carrier, a volume-average particle size of the carrier is, for example, preferably 25 μm or more and 40 μm or less, more preferably 26 μm or more and 38 μm or less, and particularly preferably 28 μm or more and 37 μm or less.

From the viewpoint of suppressing the external additive embedding in the toner, an average circularity of the carrier is, for example, 0.95 or more and 1.00 or less, more preferably 0.96 or more and 0.98 or less, and even more preferably 0.96 or more and 0.97 or less.

As for the average circularity of the carrier, 0.03 g of the carrier is dispersed in a 25% by mass aqueous solution of ethylene glycol, and using FPIA3000 (manufactured by Sysmex Corporation) as a measurement device, measurement is performed in LPF measurement mode. Thereafter, particles having a particle size of less than 10 μm and more than 50 μm are cut, and shape analysis thereof is performed.

In the first aspect, the true specific gravity of the carrier is 3.0 g/cm³ or more and 4.0 g/cm³ or less, and for example, is preferably 3.2 g/cm³ or more and 3.9 g/cm³ or less, and more preferably 3.4 g/cm³ or more and 3.6 g/cm³ or less. Even in the second aspect, the true specific gravity of the carrier is, for example, preferably 3.0 g/cm³ or more and 4.0 g/cm³ or less, more preferably 3.2 g/cm³ or more and 3.9 g/cm³ or less, and even more preferably 3.4 g/cm³ or more and 3.6 g/cm³ or less.

In a case where the true specific gravity of the carrier is within the above-described range, compared to a case of being higher than the above-described range, the embedding of the external additive in the toner is suppressed, and the fog of the image caused by the embedding of the external additive is suppressed. In addition, in a case where the true specific gravity of the carrier is within the above-described range, compared to a case of being lower than the above-described range, the fluidity of the carrier is ensured, and there are advantages of stabilizing the triboelectrification with toner and suppressing the fog of the image.

In a case where the true specific gravity of the carrier is represented by d g/cm³, from the viewpoint of suppressing the fog of the image, for example, it is preferable that a relationship between D1 (90) in the toner and the true specific gravity d in the carrier satisfies any of the following requirements 1 to 3.
Requirement 1: 3.0≤d≤3.4 and 1.4≤D1 (90)≤2.5
Requirement 2: 3.4≤d≤3.8 and 1.1≤D1 (90)<1.4
Requirement 3: 3.8≤d≤4.0 and 0.5≤D1 (90)<1.1

The reason why the fog is suppressed by satisfying the any of the requirements 1 to 3 for the relationship between D1 (90) and d is not clear, but is presumed as follows.

Specifically, in a case where a carrier having a small specific gravity is used, in order to facilitate charging due to friction at the time of contact between the toner and the carrier, for example, it is preferable to use in combination with a toner having a high viscosity on the surface, that is, a toner having a high D1 (90). On the other hand, among the toners having a specific gravity within the above-described range, in a case where a carrier having a higher specific gravity is used, the triboelectrification is likely to occur even in a combination with a toner having a small D1 (90), and the embedding of the external additive is suppressed by the combination with the toner having a small D1 (90).

From the above, in a case where the relationship between D1 (90) and d satisfies any of the requirements 1 to 3, it is presumed that the fog of the image is suppressed because the triboelectrification is likely to occur and the embedding of the external additive is suppressed.

For example, the relationship between D1 (90) and d more preferably satisfies any of the following requirements 4 to 6, and even more preferably satisfies any of the following requirements 7 to 9.
Requirement 4: 3.0≤d<3.4 and 1.45≤D1 (90)≤2.00
Requirement 5: 3.4≤d≤3.8 and 1.15≤D1 (90)<1.30
Requirement 6: 3.8≤d≤4.0 and 0.55≤D1 (90)<1.05
Requirement 7: 3.0≤d≤3.4 and 1.50≤D1 (90)≤1.80
Requirement 8: 3.4≤d<3.8 and 1.20≤D1 (90)<1.28
Requirement 9: 3.8≤d≤4.0 and 0.55≤D1 (90)<1.00

In the second aspect, the content of the magnetic powder with respect to the total amount of the carrier is more than 80% by mass and less than 90% by mass, and for example, is preferably 82% by mass or more and 87% by mass or less, and more preferably 84% by mass or more and 86% by mass or less. Even in the first aspect, the content of the magnetic powder with respect to the total amount of the carrier is, for example, preferably more than 80% by mass and less than 90% by mass, more preferably 82% by mass or more and 87% by mass or less, and even more preferably 84% by mass or more and 86% by mass or less.

In a case where the content of the magnetic powder is within the above-described range, compared to a case of being higher than the above-described range, the specific gravity of the entire carrier is smaller, the embedding of the external additive in the toner is suppressed, and the fog of the image caused by the embedding of the external additive is suppressed. In addition, in a case where the content of the magnetic powder is within the above-described range, compared to a case of being lower than the above-described range, since magnetization of the carrier increases, there is an advantage that the density of the developer on a magnetic roll of the developing device is uniform and the fog of the image is suppressed.

### Mixing Ratio of Toner and Carrier

Examples of a mixing ratio (mass ratio) of the toner and the carrier in the developer contained in the developing device include a range of 1 part by mass or more and 30 parts by mass or less of the toner with respect to 100 parts by mass of the carrier.

### Process Cartridge, Image Forming Apparatus, and Image Forming Method

Hereinafter, a process cartridge, an image forming apparatus, and an image forming method, in which the above-described developer is used, will be described.

Examples of the process cartridge according to the present exemplary embodiment include a process cartridge including a developing device that contains the above-described developer as an initially filled developer and develops an electrostatic charge image formed on a surface of an image holder into a toner image by using the developer, in which the process cartridge is attachable to and detachable from the image forming apparatus.

Examples of the image forming apparatus according to the present exemplary embodiment include an image forming apparatus including an image holder, a charging device that charges a surface of the image holder, an electrostatic charge image forming device that forms an electrostatic charge image on the charged surface of the image holder, a developing device that contains the above-described developer as an initially filled developer and develops an electrostatic charge image formed on a surface of an image holder into a toner image by using the developer, a transfer device that transfers the toner image formed on the surface of the image holder to a surface of a recording medium, and a fixing device that fixes the toner image transferred to the surface of the recording medium.

Examples of the image forming method according to the present exemplary embodiment include an image forming method including a charging step of charging a surface of an image holder, an electrostatic charge image forming step of forming an electrostatic charge image on the charged surface of the image holder; a developing step of developing an electrostatic charge image formed on a surface of the image holder as a toner image by using an initially filled developer that is a developer contained in a developing device, a transfer step of transferring the toner image formed on the surface of the image holder to a surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning device that cleans the surface of the image holder before charging after the transfer of the toner image; and an apparatus including a charge neutralization device that neutralizes charge by irradiating the surface of the image holder with charge neutralizing light before charging after the transfer of the toner image.

In the case of the intermediate transfer-type apparatus, as the transfer device, for example, a configuration is adopted which has an intermediate transfer member with surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

An example of the image forming apparatus according to the present exemplary embodiment will be shown below, but the present invention is not limited thereto. Hereinafter, among the parts shown in the drawing, main parts will be described, and others will not be described.

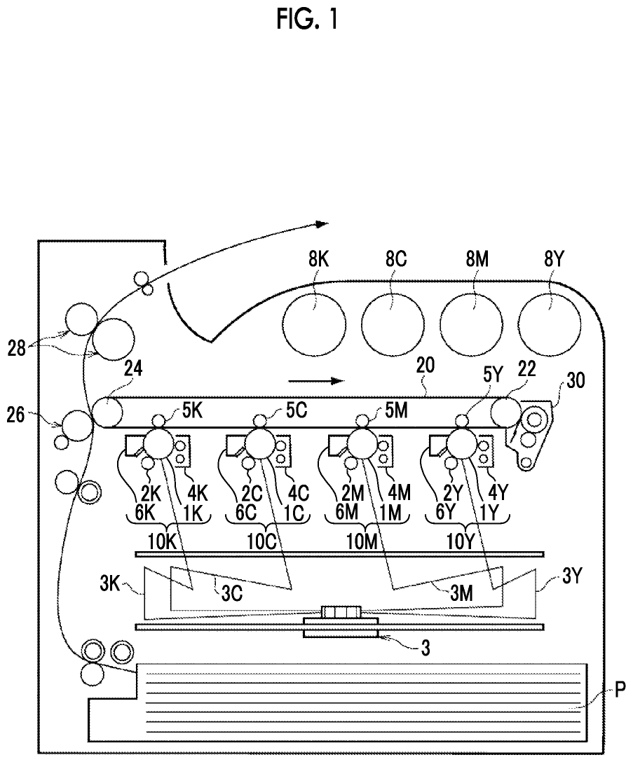

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detachable from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 which is in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the image holding surface side of the intermediate transfer belt 20.

In addition, a toner including toners having four colors of yellow, magenta, cyan, and black, that are contained in containers of toner cartridges 8Y, 8M, 8C, and 8K, is supplied to developing devices 4Y, 4M, 4C, and 4K of the units 10Y, 10M, 10C, and 10K, respectively.

The first to fourth units 10Y, 10M, 10C, and 10K have the same configuration. Therefore, in the present specification, as a representative, the first unit 10Y will be described which is placed on the upstream side of the running direction of the intermediate transfer belt and forms a yellow image. Reference numerals marked with magenta (M), cyan (C), and black (K) instead of yellow (Y) are assigned in the same portions as in the first unit 10Y, such that the second to fourth units 10M, 10C, and 10K will not be described again.

The first unit 10Y has a photoreceptor 1Y that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y As a result, an electrostatic charge image of a yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y turns into a visible image (developed image) as a toner image by the developing device 4Y.

The developing device 4Y contains, for example, an electrostatic charge image developer that contains at least a yellow toner and a carrier. By being agitated in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 A under the control of the control unit (not shown in the drawing).

On the other hand, the residual toner on the photoreceptor 1Y is removed by a photoreceptor cleaning device 6Y and collected.

In addition, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll (an example of the secondary transfer device) 26 disposed on the image holding surface side of the intermediate transfer belt 20. On the other hand, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28, the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

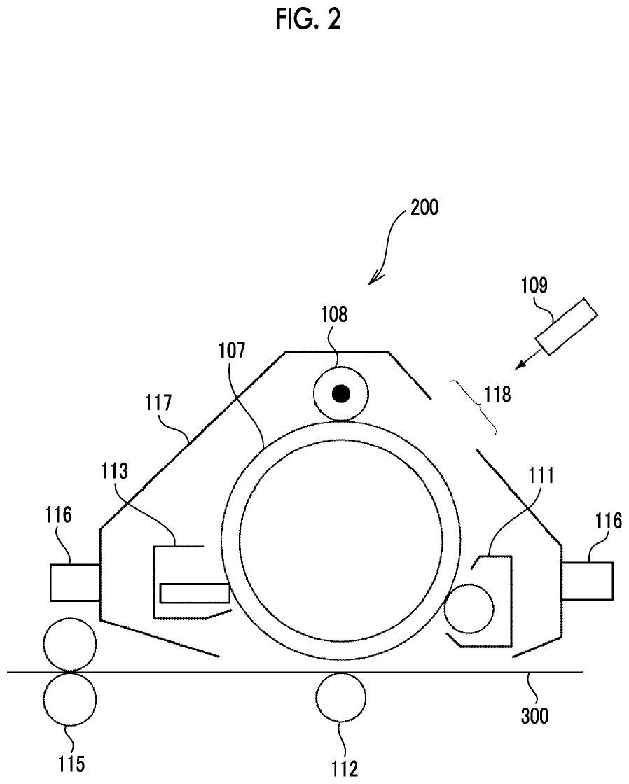

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

The process cartridge according to the present exemplary embodiment is not limited to the above configuration. The process cartridge may be configured with a developing device and, for example, at least one member selected from other units, such as an image holder, a charging device, an electrostatic charge image forming device, and a transfer device, as necessary.

### Examples

Examples will be described below, but the present invention is not limited to these examples. In the following description, unless otherwise specified, “parts” and “%” are based on mass in all cases.

### Preparation of Specific Resin Particle Dispersion

### Preparation of Specific Resin Particle Dispersion 1

Styrene: 47.9 parts
n-Butyl acrylate: 51.8 parts
2-Carboxyethyl acrylate: 0.3 parts
Anionic surfactant (Dowfax2A1 manufactured by The Dow Chemical Company): 0.8 parts
1,10-Decanediol diacrylate: 1.65 parts

The above-described raw materials are mixed together and dissolved, and 60 parts of deionized water is added thereto, followed by dispersion and emulsification in the flask, thereby producing an emulsion.

Subsequently, 1.3 parts of an anionic surfactant (DOWFAX 2A1 manufactured by The Dow Chemical Company) is dissolved in 90 parts of deionized water, 1 part of the above-described emulsion is added thereto, and 10 parts of deionized water in which 5.4 parts of ammonium persulfate is dissolved is further added thereto.

Thereafter, the rest of the emulsion is added thereto for 180 minutes, the flask is replaced with nitrogen by purging, the solution in the flask is heated up to 65° C. in an oil bath while being stirred, the emulsion polymerization is continued in the state for 500 hours, and then the solid content thereof is adjusted to 24.5% by mass, thereby obtaining a specific resin particle dispersion 1.

Results obtained by the above-described methods for the resin particles contained in the obtained specific resin particle dispersion 1 are as follows.

Glass transition temperature Tg obtained from dynamic viscoelasticity measurement: 32.1° C.
Minimum value of storage elastic modulus G′ (p90-150): 2.6×10⁵ Pa
Maximum value of storage elastic modulus G′ (p90-150): 5.1×10⁵ Pa
Minimum value of loss tangent tan δ in range of 30° C. or higher and 150° C. or lower: 0.028
Maximum value of loss tangent tan δ in range of 30° C. or higher and 150° C. or lower: 2.35
Minimum value of loss tangent tan δ in range of 65° C. or higher and 150° C. or lower: 0.028
Maximum value of loss tangent tan δ in range of 65° C. or higher and 150° C. or lower: 0.203
Number-average particle size: 153 nm
SP value (S): 9.07

### Preparation of Toner

### Preparation of Amorphous Resin Particle Dispersion 1

Terephthalic acid: 28 parts
Fumaric acid: 164 parts
Adipic acid: 10 parts
Ethylene oxide (2 mol) adduct of bisphenol A: 26 parts
Propylene oxide (2 mol) adduct of bisphenol A: 542 parts

The above-described materials are put in a reaction vessel equipped with a stirrer, a nitrogen introduction tube, a temperature sensor, and a rectifying column, the temperature is raised to 190° C. for 1 hour, and dibutyltin oxide is added to the mixture in an amount of 1.2 parts with respect to 100 parts of the above-described materials. While the generated water is distilled off, the temperature is raised to 240° C. for 6 hours, a dehydrocondensation reaction is continued for 3 hours in the reaction solution retained at 240° C., and then the reactant is cooled.

The reactant in a molten state is transferred to CAVITRON CD1010 (manufactured by Eurotech Ltd.) at a rate of 100 g/min. At the same time, separately prepared aqueous ammonia having a concentration of 0.37% by mass is transferred to CAVITRON CD1010 at a rate of 0.1 L/min in a state of being heated at 120° C. with a heat exchanger. The CAVITRON CD1010 is operated under the conditions of a rotation speed of a rotor of 60 Hz and a pressure of 5 kg/cm², thereby obtaining a resin particle dispersion in which resin particles of an amorphous polyester resin having a volume-average particle size of 169 nm are dispersed. Deionized water is added to the resin particle dispersion to adjust the solid content to 20% by mass, thereby obtaining an amorphous resin particle dispersion 1.

The SP value (R) of the obtained amorphous polyester resin is 9.41.

### Preparation of Crystalline Resin Particle Dispersion

1,10-Dodecanedioic acid: 225 parts
1,6-Hexanediol: 143 parts

The above-described materials are put in a reaction vessel equipped with a stirrer, a nitrogen introduction tube, a temperature sensor, and a rectifying column, the temperature is raised to 160° C. for 1 hour, and 0.8 parts by mass of dibutyltin oxide is added to the mixture. While the generated water is distilled off, the temperature is raised to 180° C. for 6 hours, and a dehydrocondensation reaction is continued for 5 hours in the reaction solution retained at 180° C. Thereafter, the temperature is slowly raised to 230° C. under reduced pressure, and the reaction solution is stirred for 2 hours in a state of being retained at 230° C. Thereafter, the reactant is cooled. After cooling, solid-liquid separation is performed, and the solids are dried, thereby obtaining a crystalline polyester resin.
Crystalline polyester resin: 100 parts
Methyl ethyl ketone: 40 parts
Isopropyl alcohol: 30 parts
10% aqueous ammonia solution: 6 parts

The above-described materials are put in a 3 L jacketed reaction tank (manufactured by EYELA: BJ-30N) equipped with a condenser, a thermometer, a water dripping device, and an anchor blade. In a state where the reaction tank is kept at 80° C. in a water-circulation type thermostatic bath, and the materials are stirred and mixed together at 100 rpm, the resin is dissolved. Thereafter, the water-circulation type thermostatic bath is set to 50° C., and a total of 400 parts of deionized water retained at 50° C. is added dropwise to the reaction tank at a rate of 7 parts by mass/min to cause phase inversion, thereby obtaining an emulsion. 576 parts by mass of the obtained emulsion and 500 parts by mass of deionized water are put in a 2 L eggplant flask and set in an evaporator (manufactured by EYELA) equipped with a vacuum controlled unit via a trap ball. While being rotated, the eggplant flask is heated in a hot water bath at 60° C., and the pressure is reduced to 7 kPa with care to sudden boiling, thereby removing the solvent. The volume-average particle size D50v of the resin particles in the dispersion is 185 nm. Thereafter, deionized water is added thereto to obtain a crystalline resin particle dispersion having a solid content concentration of 22.1% by mass.

### Preparation of Colorant Dispersion

Cyan pigment (Pigment Blue 15: 3 (copper phthalocyanine), manufactured by Dainichiseika Color & Chemicals Mfg. Co., Ltd.): 98 parts
Anionic surfactant (TaycaPower manufactured by Tayca Corporation): 2 parts
Deionized water: 420 parts

The above-described components are mixed together, dissolved, and dispersed with a homogenizer (TKA ULTRA-TURRAX) for 10 minutes, thereby obtaining a colorant dispersion having a central particle size of 164 nm and a solid content of 21.1% by mass.

### Preparation of Release Agent Dispersion

Synthetic wax (manufactured by NIPPON SEIRO CO., LTD., FNP92, melting temperature Tw: 92° C.): 50 parts
Anionic surfactant (TaycaPower manufactured by Tayca Corporation): 1 part
Deionized water: 200 parts

The above-described materials are mixed together, heated to 130° C., and dispersed using a homogenizer (ULTRA-TURRAX T50 manufactured by IKA). Thereafter, using Manton-Gaulin high-pressure homogenizer (manufactured by Gaulin), dispersion treatment is performed, thereby obtaining a release agent dispersion (solid content: 20% by mass) in which release agent particles are dispersed.

The volume-average particle size of the release agent particles is 214 nm.

### Preparation of Toner 1

Amorphous resin particle dispersion 1: 169 parts
Specific resin particle dispersion 1: 33 parts
Crystalline resin particle dispersion: 53 parts
Release agent dispersion: 25 parts
Colorant dispersion: 33 parts
Anionic surfactant (Dowfax2A1 manufactured by The Dow Chemical Company): 4.8 parts

The above-described raw materials with a liquid temperature adjusted to 10° C. are put in a 3 L cylindrical stainless steel container, and dispersed and mixed together for 2 minutes in a state where a shearing force is applied at 4,000 rpm by a homogenizer (ULTRA-TURRAX T50 manufactured by IKA).

Next, 1.75 parts of a 10% aqueous nitric acid solution of aluminum sulfate as an aggregating agent is slowly added dropwise to the mixture, and dispersed and mixed for 10 minutes by the homogenizer at a rotation speed of 10,000 rpm, thereby obtaining a raw material dispersion.

Thereafter, the raw material dispersion is moved to a polymerization tank equipped with a stirrer using two paddles as stirring blades and a thermometer, and start to be heated with a mantle heater at a rotation speed for stirring of 550 rpm, and then the growth of aggregated particles is promoted at 40° C. In this case, by using 0.3 M nitric acid and a 1 M aqueous sodium hydroxide solution, the pH of the raw material dispersion is controlled in a range of 2.2 to 3.5. The raw material dispersion is retained in the above-described pH range for approximately 2 hours so that aggregated particles are formed.

Next, a dispersion prepared by mixing 21 parts of the amorphous resin particle dispersion 1 with 8 parts of the specific resin particle dispersion 1 is further added thereto, and the obtained dispersion is retained for 60 minutes so that the binder resin particles and the specific resin particles adhere to the surface of the aggregated particles. The dispersion is further heated to 53° C., 21 parts of the amorphous resin particle dispersion 1 is further added thereto, and the obtained dispersion is retained for 60 minutes so that the binder resin particles adhere to the surface of the aggregated particles.

Aggregated particles are prepared in a state where the size and shape of particles are checked using an optical microscope and MULTISIZER 3. Thereafter, pH is adjusted to 7.8 using a 5% aqueous sodium hydroxide solution, and the dispersion is retained for 15 minutes.

Thereafter, the pH is raised to 8.0 so that the aggregated particles are coalesced, and then the dispersion is heated up to 85° C. Two hours after the coalesce of the aggregated particles is confirmed using an optical microscope, heating is stopped, and the dispersion is cooled at a cooling rate of 1.0° C./min. Subsequently, the particles are sieved with a 20 μm mesh, repeatedly washed with water, and then dried in a vacuum dryer, thereby obtaining toner particles 1 having a volume-average particle size of 5.3 m.

100 parts of the obtained toner particles and 0.7 parts of silica particles treated with dimethylsilicone oil (RY200 manufactured by Nippon Aerosil Co., Ltd.) are mixed together by a henschel mixer, thereby obtaining a toner 1.

### Preparation of Toner 2

A toner 2 is obtained in the same manner as the toner 1, except that the specific resin particle dispersion 1 is used in such an amount that the content of the specific resin particles with respect to the total amount of the toner particles is the value shown in Table 1, and the pH during the coalesce of the aggregated particles is changed from 8.0 to 6.0.

### Preparation of Toner 3

A toner 3 is obtained in the same manner as the toner 1, except that the specific resin particle dispersion 1 is used in such an amount that the content of the specific resin particles with respect to the total amount of the toner particles is the value shown in Table 1.

### Preparation of Toner 4

A toner 4 is obtained in the same manner as the toner 1, except that the pH during the coalesce of the aggregated particles is changed from 8.0 to 6.5, the temperature after heating is changed from 85° C. to 75° C., and 5.2 parts of the anionic surfactant (DOWFAX 2A1 manufactured by The Dow Chemical Company) is added at the time the temperature reaches 75° C.

### Preparation of Toner C1

Amorphous resin particle dispersion 1: 169 parts
Specific resin particle dispersion 1: 41 parts
Crystalline resin particle dispersion: 53 parts
Release agent dispersion: 25 parts
Colorant dispersion: 33 parts
Anionic surfactant (Dowfax2A1 manufactured by The Dow Chemical Company): 4.8 parts

The above-described raw materials with a liquid temperature adjusted to 30° C. are put in a 3 L cylindrical stainless steel container, and dispersed and mixed together for 2 minutes in a state where a shearing force is applied at 4,000 rpm by a homogenizer (ULTRA-TURRAX T50 manufactured by IKA).

Next, 1.75 parts of a 10% aqueous nitric acid solution of aluminum sulfate as an aggregating agent is slowly added dropwise to the mixture, and dispersed and mixed for 3 minutes by the homogenizer at a rotation speed of 4,000 rpm, thereby obtaining a raw material dispersion.

Thereafter, the raw material dispersion is moved to a polymerization tank equipped with a stirrer using two paddles as stirring blades and a thermometer, and start to be heated with a mantle heater at a rotation speed for stirring of 550 rpm, and then the growth of aggregated particles is promoted at 40° C. In this case, by using 0.3 M nitric acid and a 1 M aqueous sodium hydroxide solution, the pH of the raw material dispersion is controlled in a range of 2.2 to 3.5. The raw material dispersion is retained in the above-described pH range for approximately 2 hours so that aggregated particles are formed.

Next, 42 parts of the amorphous resin particle dispersion 1 is further added thereto, and the obtained dispersion is retained for 60 minutes so that the binder resin particles adhere to the surface of the aggregated particles.

Aggregated particles are prepared in a state where the size and shape of particles are checked using an optical microscope and MULTISIZER 3. Thereafter, pH is adjusted to 7.8 using a 5% aqueous sodium hydroxide solution, and the dispersion is retained for 15 minutes.

Thereafter, the pH is raised to 8.0 so that the aggregated particles are coalesced, and then the dispersion is heated up to 85° C. Two hours after the coalesce of the aggregated particles is confirmed using an optical microscope, heating is stopped, and the dispersion is cooled at a cooling rate of 1.0° C./min. Subsequently, the particles are sieved with a 20 μm mesh, repeatedly washed with water, and then dried in a vacuum dryer, thereby obtaining toner particles Cl.

100 parts of the obtained toner particles and 0.7 parts of silica particles treated with dimethylsilicone oil (RY200 manufactured by Nippon Aerosil Co., Ltd.) are mixed together by a henschel mixer, thereby obtaining a toner C1.

Regarding the obtained toners, Table 1 shows the content of the specific resin particles with respect to the total amount of the toner particles (“Particle content (%)” in the table).

In addition, regarding the obtained toners, Table 1 also shows the ratio of the content of the crystalline resin to the content of the specific resin particles (“Crystalline content ratio vs particles” in the table) and the ratio of the content of the amorphous resin to the content of the specific resin particles (“Amorphous content ratio vs particles” in the table) in the obtained toner.

In addition, regarding the obtained toners, Table 1 also shows the volume-average particle size of the toner particles in the obtained toner.

Furthermore, Table 1 shows the storage elastic modulus G′ of the extra components in a range of 30° C. or higher and 50° C. or lower (“30° C.-50° C. G′(Pa)” in the table), the specific elastic modulus reached temperature of the extra components (“Reached temperature (° C.)” in the table), and the loss tangent tan δ at the specific elastic modulus reached temperature (“Reached temperature tan” in the table), that are determined by the methods described above.

In addition, regarding the obtained toners, Table 2 shows D1 (90), D50 (90), D1 (150), D50 (150), the value of D50 (150)−D1 (150) (“Difference (150)” in the table), the value of D50 (90)−D1 (90) (“Difference (90)” in the table), the number-average molecular weight of the THF-soluble components in the toner particles (“Mn” in the table), the storage elastic modulus G′ in a range of 30° C. or higher and 50° C. or lower (“30° C.-50° C. G′(Pa)” in the table), the specific elastic modulus reached temperature (“Reached temperature (° C.)” in the table), the value of log G′(t90-150)−log G′(r90-150) (“Difference in viscoelasticity” in the table), and the difference (SP value (S)−SP value (R)) (“Difference in SP value” in the table), that are determined by the methods described above.

TABLE 1

| | | Crystalline | Amorphous | Toner particles | Extra component | | |
|---|---|---|---|---|---|---|---|
| | Particles | content | content | Volume-average | 30° C.- | Reached | Reached |
| | Content | ratio vs | ratio vs | particle | 50° C. | temperature | temperature |
| Toner | (%) | particles | particles | size (μm) | G′(Pa) | (° C.) | tanδ |
| 1 | 10 | 1.35 | 7.65 | 5.3 | 3.0 × 10⁸-5.3 × 10⁸ | 72 | 1.4 |
| 2 | 19 | 0.64 | 3.62 | 4.7 | 3.0 × 10⁸-5.3 × 10⁸ | 75 | 0.92 |
| 3 | 1 | 14.85 | 84.15 | 4.8 | 3.0 × 10⁸-5.3 × 10⁸ | 72 | 1.4 |
| 4 | 10 | 0.26 | 1.45 | 5.0 | 3.0 × 10⁸-5.3 × 10⁸ | 72 | 1.4 |
| C1 | 10 | 1.35 | 7.65 | 4.3 | 3.0 × 10⁸-5.3 × 10⁸ | 72 | 1.4 |

TABLE 2

| | | | | | | | | 30° C.- | Reached | Difference | Difference |
|---|---|---|---|---|---|---|---|---|---|---|---|
| | D1 | D50 | D1 | D50 | Difference | Difference | | 50° C. | temperature | in visco- | in SP |
| Toner | (90) | (90) | (150) | (150) | (150) | (90) | Mn | G′(Pa) | (° C.) | elasticity | value |
| 1 | 1.21 | 1.42 | 0.60 | 1.53 | 0.93 | 0.21 | 8891 | 2.5 × 10⁸-4.8 × 10⁸ | 82 | 3.3 | −0.26 |
| 2 | 0.55 | 0.74 | 0.63 | 1.53 | 0.90 | 0.19 | 7815 | 2.2 × 10⁸-4.5 × 10⁸ | 84 | 3.7 | −0.26 |
| 3 | 1.52 | 1.83 | 0.61 | 1.96 | 1.35 | 0.31 | 7624 | 2.9 × 10⁸-5.4 × 10⁸ | 81 | 3.7 | −0.26 |
| 4 | 1.31 | 1.62 | 0.67 | 1.94 | 1.27 | 0.31 | 16892 | 2.9 × 10⁸-5.1 × 10⁸ | 86 | 3.2 | −0.26 |
| C1 | 1.18 | 2.23 | 0.63 | 2.27 | 1.64 | 1.05 | 8209 | 2.9 × 10⁸-5.1 × 10⁸ | 83 | 3.1 | −0.26 |

### Production of Carrier

### Production of Core Particles

Magnetite powder (volume-average particle size: 0.2 μm), phenol, 36% by mass formarin, deionized water, and 26% by mass aqueous ammonia solution are mixed with each other at the addition amounts shown in Table 3, and the mixture is heated to 85° C. while stirring, and then reacted and cured over 4 hours.

Thereafter, cooling, filtration, and washing with deionized water are carried out to obtain core particles.

TABLE 3

| | Addition amount (part by mass) | | | | |
|---|---|---|---|---|---|
| | | | | Ion- | Ammonia |
| Core | | | | exchanged | aqueous |
| particles | Magnetite | Phenol | Formarin | water | solution |
| 1 | 400 | 50 | 60 | 60 | 16 |
| 2 | 355 | 50 | 59 | 60 | 16 |
| 3 | 580 | 46 | 56 | 60 | 15 |
| 4 | 400 | 50 | 60 | 60 | 16 |
| 5 | 360 | 56 | 63 | 60 | 17 |
| 6 | 670 | 46 | 56 | 60 | 15 |
| C1 | 720 | 46 | 57 | 60 | 14 |

### Formation of Thin Film Layer

### Production of Core Materials 1 to 6 and C1

Melamine and 36% by mass formarin are mixed with each other at the addition amounts shown in Table 4, and the mixture is heated to 60° C. at a temperature rising rate of 1° C./1 minute while stirring, and then heated at 60° C. for 1 hour to obtain a melamine solution.

On the other hand, a core particle dispersion obtained by mixing 60 parts of deionized water and 400 parts of the core particles shown in Table 4 is heated to 85° C., the above-described melamine solution is added thereto, and the mixture is stirred at 85° C. for 2 hours.

Next, cooling, filtration, and washing with deionized water are carried out to obtain a core material in which a thin film layer is formed on a surface of the core particles.

Regarding the obtained core material, Table 4 shows the volume-average particle size (“Particle size” in the table), the true specific gravity, the average thickness of the thin film layer (“Film thickness” in the table), and the content of the magnetic powder with respect to the total amount of the core material (“Magnetic powder ratio” in the table).

“−” in the table indicates that the substance is not added.

TABLE 4

| | | | | Characteristics | | | |
|---|---|---|---|---|---|---|---|
| | Core | Addition amount | | Particle | True specific | Film | Magnetic |
| Core | particles | (part by mass) | | size | gravity | thickness | powder ratio |
| material | Type | Melamine | Formalin | (μm) | (g/cm³) | (μm) | (% by mass) |
| 1 | 1 | 2.5 | 6 | 35 | 3.6 | 0.10 | 86 |
| 2 | 2 | 2.4 | 6 | 35 | 3.1 | 0.15 | 85 |
| 3 | 3 | 2.6 | 6 | 35 | 4.0 | 0.15 | 87 |
| 4 | 4 | — | — | 35 | 3.6 | — | 86 |
| 5 | 5 | 2.4 | 6 | 35 | 3.1 | 0.15 | 83 |
| 6 | 6 | 2.6 | 6 | 35 | 4.1 | 0.12 | 89 |
| C1 | C1 | 2.7 | 6 | 35 | 4.2 | 0.13 | 92 |

### Preparation of Coating Agent

Cyclohexyl methacrylate (weight-average molecular weight: 50,000): 36 parts
Carbon black (VXC72 manufactured by Cabot Corporation.): 4 parts
Toluene: 300 parts

The above-described components and glass beads (particle size: 1 mm, the same amount as toluene) are put in a sand mill manufactured by Kansai Paint Co., Ltd., and stirred at a rotation speed of 1200 rpm for 30 minutes, thereby preparing a coating agent having a solid content of 11% by mass.

### Production of Carrier

2000 g of the core material shown in Table 5 is added to a vacuum degassing type 5 L kneader, and the above-described coating agent is further added thereto in the amount shown in Table 5. While stirring, the pressure is reduced to a gauge pressure of 200 mmHg at 60° C. for 15 minutes, and under heating and reduced pressure, the mixture is stirred and dried at a temperature of 94° C. and a gauge pressure of 720 mmHg for 30 minutes, and then sieved with a sieving screen of 75 μm mesh to obtain a carrier in which the resin coating layer is formed in the core material.

Regarding the obtained carrier, Table 5 shows the volume-average particle size (“Particle size” in the table), the true specific gravity, the average thickness of the resin coating layer (“Film thickness” in the table), the average circularity, and the content of the magnetic powder with respect to the total amount of the carrier (“Magnetic powder ratio” in the table).

TABLE 5

| | | Coating agent | Characteristics | | | | |
|---|---|---|---|---|---|---|---|
| | Core | Addition | Particle | True specific | Film | | Magnetic |
| | material | amount | size | gravity | thickness | Average | powder ratio |
| Carrier | Type | (g) | (μm) | (g/cm³) | (μm) | circularity | (% by mass) |
| 1 | 1 | 370 | 35 | 3.5 | 0.8 | 0.96 | 85 |
| 2 | 2 | 370 | 35 | 3.0 | 0.8 | 0.96 | 84 |
| 3 | 3 | 370 | 35 | 3.9 | 0.8 | 0.95 | 86 |
| 4 | 4 | 370 | 35 | 3.0 | 0.8 | 0.96 | 84 |
| 5 | 5 | 370 | 35 | 3.0 | 0.8 | 0.98 | 81 |
| 6 | 6 | 280 | 35 | 4.0 | 0.6 | 0.98 | 88 |
| C1 | C1 | 370 | 35 | 4.1 | 0.8 | 0.94 | 91 |

### Production of Developer

8 parts of the toner shown in Table 6 and 100 parts of the carrier shown in Table 6 are mixed to obtain a developer. Regarding the obtained developer, Table 6 shows the corresponding requirement of the requirements 1 to 3 (“Requirements 1 to 3” in the table), the corresponding requirement of the requirements 4 to 6 (“Requirements 4 to 6” in the table), and the corresponding requirement of the requirements 7 to 9 (“Requirements 7 to 9” in the table). “None” in the table indicates that none of the requirements are met.

### Evaluation of Developer

### Difference in Glossiness

A developing device of a color copy machine ApeosPortIV C3370 (manufactured by FUJIFILM Business Innovation Corp.) from which a fixing device has been detached is filled with the obtained developer, a toner application amount is adjusted to 0.45 mg/cm², and an unfixed image is printed out. As a recording medium, OS-coated W paper A4 size (basis weight: 127 gsm) manufactured by FUJIFILM Business Innovation Corp. is used. The image printed out is an image having a size of 50 mm×50 mm and an image density of 100%.

A device used for evaluating fixing is prepared by detaching a fixing device from ApeosPortIV C3370 manufactured by FUJIFILM Business Innovation Corp., and modifying the machine so that nip pressure and fixing temperature can be changed. The process speed is 175 mm/sec.

Under these conditions, the unfixed image is fixed under two conditions, a low-temperature and low-pressure condition (specifically, a fixing device temperature of 120° and a nip pressure of 1.6 kgf/cm²) and a high-temperature and high-pressure condition (specifically, a fixing device temperature of 1800 and a nip pressure of 6.0 kgf/cm²), thereby obtaining a fixed image. Using a gloss meter, micro-TRI-gloss manufactured by BYK, the glossiness of the portion of the fixed image is measured by 60° gloss, and a difference in glossiness between the fixed image fixed under the low-temperature and low-pressure condition and the fixed image fixed under the high-temperature and high-pressure condition (that is, a difference in glossiness conditions) is determined. The results are shown in Table 6.

In a case where the difference in glossiness is less than 5, it is difficult to visually recognize the difference in glossiness; in a case where the difference in glossiness is 5 or more and less than 10, the difference in glossiness can be visually recognized, but is minor; in a case where the difference in glossiness is 10 or more and less than 15, the difference in glossiness is observed, but is within the acceptable range; and in a case where the difference in glossiness is 15 or more, the difference in glossiness is large and out of the acceptable range.

### Fog

The fog is evaluated using an image forming apparatus (DC VII C7773).

Specifically, on a paper that is an A4 size recording medium under the conditions of 23° C. and 15% RH, an image composed of a total of 24 A to Z text (4 text per line, 6 lines) with font: MS Gothic and size: 14 points is printed on 100,000 sheets. Thereafter, the image forming apparatus is moved to an environment of 28° C. and 85% RH, and 20 sheets of A4 solid image (image density: 100%) are printed. Next, 10 images having a length of 15 cm and intervals of 5 cm are printed on an A4 paper that is a recording medium having monochromatic Kuro lines with a size of 1 point, and the obtained images are evaluated according to the following standard. The results are shown in Table 6.

G1: lines are printed without problems.

G2: in observation with 25× magnifying glass, variations in line thickness are confirmed.

G3: in observation with 25× magnifying glass, faint toner fog is confirmed around the line.

G4: in visual observation, faint toner fog is confirmed around the line.

G5: the toner is fogged around the line, and the line is blurred.

TABLE 6

| | | | Relationship between D1 (90) and d | | | Evaluation | |
|---|---|---|---|---|---|---|---|
| | Toner | Carrier | Requirements | Requirements | Requirements | difference in | |
| | Type | Type | 1 to 3 | 4 to 6 | 7 to 9 | glossiness | Fog |
| Example 1 | 3 | 2 | Requirement 1 | Requirement 4 | Requirement 7 | 14.2 | G2 |
| Example 2 | 1 | 1 | Requirement 2 | Requirement 5 | Requirement 8 | 4.8 | G1 |
| Example 3 | 2 | 3 | Requirement 3 | Requirement 6 | Requirement 9 | 8.1 | G2 |
| Example 4 | 3 | 1 | None | None | None | 14.2 | G3 |
| Example 5 | 2 | 1 | None | None | None | 8.1 | G3 |
| Example 6 | 1 | 2 | None | None | None | 4.8 | G3 |
| Example 7 | 1 | 3 | None | None | None | 4.8 | G3 |
| Example 8 | 1 | 4 | Requirement 1 | None | None | 4.8 | G4 |
| Example 9 | 1 | 5 | Requirement 1 | None | None | 4.8 | G3 |
| Example 10 | 1 | 6 | None | None | None | 4.8 | G4 |
| Example 11 | 4 | 2 | Requirement 1 | Requirement 4 | None | 10.8 | G2 |
| Comparative | 1 | C1 | None | None | None | 4.8 | G5 |
| Example 1 | | | | | | | |
| Comparative | C1 | 1 | Requirement 2 | Requirement 5 | None | 23.9 | G2 |
| Example 2 | | | | | | | |

From the above-described results, it is found that, with the developer according to the present example, a difference in glossiness between a fixed image under a low-temperature and low-pressure condition and a fixed image under a high-temperature and high-pressure condition is small, and fog of an image is suppressed.

The present exemplary embodiment includes the following aspects.

(((1)))

An electrostatic charge image developer comprising:
a toner including toner particles that contain a binder resin, and an external additive; and
a carrier having a true specific gravity of 3.0 g/cm³ or more and 4.0 g/cm³ or less,
wherein, in a dynamic viscoelasticity measurement of the toner, in a case where a loss tangent tan δ at a temperature of 90° C. and a strain of 1% is represented by D1 (90), a loss tangent tan δ at a temperature of 90° C. and a strain of 50% is represented by D50 (90), a loss tangent tan δ at a temperature of 150° C. and a strain of 1% is represented by D1 (150), and a loss tangent tan δ at a temperature of 150° C. and a strain of 50% is represented by D50 (150),
each of D1 (90), D50 (90), D1 (150), and D50 (150) is 0.5 or more and 2.5 or less,
a value of D50 (150)−D1 (150) is less than 1.5, and
a value of D50 (90)−D1 (90) is less than 1.0.
   (((2)))

The electrostatic charge image developer according to (((1))),
wherein, in a case where the true specific gravity of the carrier is represented by d g/cm³, a relationship between D1 (90) and d satisfies any of the following requirements 1 to 3,
the requirement 1: 3.0≤d<3.4 and 1.4≤D1 (90)≤2.5,
the requirement 2: 3.4≤d<3.8 and 1.1≤D1 (90)<1.4, and
the requirement 3: 3.8≤d≤4.0 and 0.5≤D1 (90)<1.1.
   (((3)))

The electrostatic charge image developer according to (((1))) or (((2))),

wherein the carrier contains core particles in which a magnetic powder is dispersed in a resin, a first resin layer that coats a surface of the core particles, and a second resin layer that coats an outer peripheral surface of the first resin layer.

(((4)))

The electrostatic charge image developer according to (((3))),
wherein the first resin layer contains a melamine resin.
   (((5)))

The electrostatic charge image developer according to any one of (((1))) to (((4))),
wherein the toner particles further contain resin particles.
   (((6)))

The electrostatic charge image developer according to (((5))),
wherein the resin particles are crosslinked resin particles.
   (((7)))

The electrostatic charge image developer according to (((6))),
wherein the crosslinked resin particles are styrene (meth)acrylic resin particles.
   (((8)))

The electrostatic charge image developer according to any one of (((1))) to (((7))),
wherein a number-average molecular weight of tetrahydrofuran-soluble components in the toner particles is 5,000 or more and 15,000 or less.
   (((9)))

An electrostatic charge image developer comprising:
a toner including toner particles that contain a binder resin, and an external additive; and
a carrier containing core particles in which a magnetic powder is dispersed in a resin,
wherein, in a dynamic viscoelasticity measurement of the toner, in a case where a loss tangent tan δ at a temperature of 90° C. and a strain of 1% is represented by D1 (90), a loss tangent tan δ at a temperature of 90° C. and a strain of 50% is represented by D50 (90), a loss tangent tan δ at a temperature of 150° C. and a strain of 1% is represented by D1 (150), and a loss tangent tan δ at a temperature of 150° C. and a strain of 50% is represented by D50 (150),
each of D1 (90), D50 (90), D1 (150), and D50 (150) is 0.5 or more and 2.5 or less,
a value of D50 (150)−D1 (150) is less than 1.5, and
a value of D50 (90)−D1 (90) is less than 1.0, and
a content of the magnetic powder with respect to a total amount of the carrier is more than 80% by mass and less than 90% by mass.
   (((10)))

A process cartridge comprising:
a developing device that contains the electrostatic charge image developer according to any one of (((1))) to (((9))) and develops an electrostatic charge image formed on a surface of an image holder as a toner image by using the electrostatic charge image developer,
wherein the process cartridge is attachable to and detachable from an image forming apparatus.
   (((11)))

An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to any one of (((1))) to (((9))) and develops the electrostatic charge image formed on the surface of the image holder as a toner image by using the electrostatic charge image developer;
a transfer device that transfers the toner image formed on the surface of the image holder to a surface of a recording medium; and
a fixing device that fixes the toner image transferred to the surface of the recording medium.
   (((12)))

An image forming method comprising:
charging a surface of an image holder;
forming an electrostatic charge image on the charged surface of the image holder;
developing the electrostatic charge image formed on the surface of the image holder as a toner image by using the electrostatic charge image developer according to any one of (((1))) to (((9)));
transferring the toner image formed on the surface of the image holder to a surface of a recording medium; and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developer comprising:
a toner including toner particles that contain a binder resin, and an external additive; and
a carrier having a true specific gravity of 3.0 g/cm³ or more and 4.0 g/cm³ or less,
wherein, in a dynamic viscoelasticity measurement of the toner, in a case where a loss tangent tan δ at a temperature of 90° C. and a strain of 1% is represented by D1 (90), a loss tangent tan δ at a temperature of 90° C. and a strain of 50% is represented by D50 (90), a loss tangent tan δ at a temperature of 150° C. and a strain of 1% is represented by D1 (150), and a loss tangent tan δ at a temperature of 150° C. and a strain of 50% is represented by D50 (150),
each of D1 (90), D50 (90), D1 (150), and D50 (150) is 0.5 or more and 2.5 or less,
a value of D50 (150)−D1 (150) is less than 1.5, and
a value of D50 (90)−D1 (90) is less than 1.0.

2. The electrostatic charge image developer according to claim 1,
wherein, in a case where the true specific gravity of the carrier is represented by d g/cm³, a relationship between D1 (90) and d satisfies any of the following requirements 1 to 3,
the requirement 1: 3.0≤d<3.4 and 1.4≤D1 (90)≤2.5,
the requirement 2: 3.4≤d<3.8 and 1.1≤D1 (90)<1.4, and
the requirement 3: 3.8≤d≤4.0 and 0.5≤D1 (90)<1.1.

3. The electrostatic charge image developer according to claim 1,
wherein the carrier contains core particles in which a magnetic powder is dispersed in a resin, a first resin layer that coats a surface of the core particles, and a second resin layer that coats an outer peripheral surface of the first resin layer.

4. The electrostatic charge image developer according to claim 3,
wherein the first resin layer contains a melamine resin.

5. The electrostatic charge image developer according to claim 1,
wherein the toner particles further contain resin particles.

6. The electrostatic charge image developer according to claim 5,
wherein the resin particles are crosslinked resin particles.

7. The electrostatic charge image developer according to claim 6,
wherein the crosslinked resin particles are styrene (meth)acrylic resin particles.

8. The electrostatic charge image developer according to claim 1,
wherein a number-average molecular weight of tetrahydrofuran-soluble components in the toner particles is 5,000 or more and 15,000 or less.

9. An electrostatic charge image developer comprising:
a toner including toner particles that contain a binder resin, and an external additive; and
a carrier containing core particles in which a magnetic powder is dispersed in a resin,
wherein, in a dynamic viscoelasticity measurement of the toner, in a case where a loss tangent tan δ at a temperature of 90° C. and a strain of 1% is represented by D1 (90), a loss tangent tan δ at a temperature of 90° C. and a strain of 50% is represented by D50 (90), a loss tangent tan δ at a temperature of 150° C. and a strain of 1% is represented by D1 (150), and a loss tangent tan δ at a temperature of 150° C. and a strain of 50% is represented by D50 (150),
each of D1 (90), D50 (90), D1 (150), and D50 (150) is 0.5 or more and 2.5 or less,
a value of D50 (150)−D1 (150) is less than 1.5, and
a value of D50 (90)−D1 (90) is less than 1.0, and
a content of the magnetic powder with respect to a total amount of the carrier is more than 80% by mass and less than 90% by mass.

10. A process cartridge comprising:
a developing device that contains the electrostatic charge image developer according to claim 1 and develops an electrostatic charge image formed on a surface of an image holder as a toner image by using the electrostatic charge image developer,
wherein the process cartridge is attachable to and detachable from an image forming apparatus.

11. A process cartridge comprising:
a developing device that contains the electrostatic charge image developer according to claim 2 and develops an electrostatic charge image formed on a surface of an image holder as a toner image by using the electrostatic charge image developer,
wherein the process cartridge is attachable to and detachable from an image forming apparatus.

12. A process cartridge comprising:
a developing device that contains the electrostatic charge image developer according to claim 3 and develops an electrostatic charge image formed on a surface of an image holder as a toner image by using the electrostatic charge image developer,
wherein the process cartridge is attachable to and detachable from an image forming apparatus.

13. A process cartridge comprising:
a developing device that contains the electrostatic charge image developer according to claim 4 and develops an electrostatic charge image formed on a surface of an image holder as a toner image by using the electrostatic charge image developer,
wherein the process cartridge is attachable to and detachable from an image forming apparatus.

14. A process cartridge comprising:
a developing device that contains the electrostatic charge image developer according to claim 5 and develops an electrostatic charge image formed on a surface of an image holder as a toner image by using the electrostatic charge image developer,
wherein the process cartridge is attachable to and detachable from an image forming apparatus.

15. A process cartridge comprising:
a developing device that contains the electrostatic charge image developer according to claim 6 and develops an electrostatic charge image formed on a surface of an image holder as a toner image by using the electrostatic charge image developer,
wherein the process cartridge is attachable to and detachable from an image forming apparatus.

16. A process cartridge comprising:
a developing device that contains the electrostatic charge image developer according to claim 7 and develops an electrostatic charge image formed on a surface of an image holder as a toner image by using the electrostatic charge image developer,
wherein the process cartridge is attachable to and detachable from an image forming apparatus.

17. A process cartridge comprising:
a developing device that contains the electrostatic charge image developer according to claim 8 and develops an electrostatic charge image formed on a surface of an image holder as a toner image by using the electrostatic charge image developer,
wherein the process cartridge is attachable to and detachable from an image forming apparatus.

18. A process cartridge comprising:
a developing device that contains the electrostatic charge image developer according to claim 9 and develops an electrostatic charge image formed on a surface of an image holder as a toner image by using the electrostatic charge image developer,
wherein the process cartridge is attachable to and detachable from an image forming apparatus.

19. An image forming apparatus comprising:
an image holder;
a charging device that charges a surface of the image holder;
an electrostatic charge image forming device that forms an electrostatic charge image on the charged surface of the image holder;
a developing device that contains the electrostatic charge image developer according to claim 1 and develops the electrostatic charge image formed on the surface of the image holder as a toner image by using the electrostatic charge image developer;
a transfer device that transfers the toner image formed on the surface of the image holder to a surface of a recording medium; and
a fixing device that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image by using the electrostatic charge image developer according to claim 1;
transferring the toner image formed on the surface of the image holder to a surface of a recording medium; and
fixing the toner image transferred to the surface of the recording medium.
